(19) United States
(12) Patent Application Publication
(10) Pub. No.: US 2022/0291605 A1
(43) Pub. Date: Sep. 15, 2022

(54) METHODS FOR FORMING STRUCTURED IMAGES AND RELATED ASPECTS

(71) Applicant: Hewlett-Packard Development Company, L.P., Spring, TX (US)

(72) Inventors: Gideon AMIR, Nes Ziona (IL); Tony AZZAM, Nes Ziona (IL); Michael KOKOTOV, Nes Ziona (IL)

(73) Assignee: Hewlett-Packard Development Company, L.P., Spring, TX (US)

(21) Appl. No.: 17/635,080

(22) PCT Filed: Jan. 9, 2020
(86) PCT No.: PCT/US2020/012887

§ 371 Date: Feb. 14, 2022

(51) Int. Cl. G03G 9/135; G03G 9/13; G03G 9/12; G03G 15/16

(52) U.S. Cl. CPC G03G 9/135; G03G 9/131; G03G 9/122; G03G 15/162

(57) ABSTRACT

An electrostatic printing method for forming a structured image on a print substrate, the method comprising: providing an electrostatic ink composition; contacting the electrostatic ink composition with a latent electrostatic image on a photoconductive surface to create a developed toner image; transferring the developed toner image to an embossed intermediate transfer member to create a structured toner image; and; transferring the structured toner image to a print substrate. The embossed intermediate transfer may comprise a substrate layer, at least part of which is compressible and comprises an electrically conductive species; and; an outer release layer disposed on the substrate layer, the outer release layer comprising a structured surface. Methods of making the embossed intermediate transfer member are also described herein.

### BACKGROUND

Electrostatic printing processes typically involve creating an image on a photoconductive surface, applying an ink having charged particles to the photoconductive surface, such that they selectively bind to the image, and then transferring the charged particles in the form of the image to a print substrate.

The photoconductive surface is typically on a cylinder and is often termed a photo imaging plate (PIP). The photoconductive surface is selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, more commonly, by being first transferred to an intermediate transfer member and then to the print substrate.

Structured Images, such as holograms or watermarks, can be used to increase visual appeal, authenticate an original product or increase consumer confidence. Previous methods to form holograms or watermarks involve stamping an ink after printing. Other methods to form holograms or watermarks involve affixing holographic or watermarked material, such as a label or foil, to a printed substrate.

### BRIEF DESCRIPTION OF THE FIGURES

FIG. 1 is a schematic illustration of an example of an electrostatic printing apparatus comprising an example embossed intermediate transfer member (ITM).

FIG. 2 is a schematic showing the chemical structures of components in the Example curable primer formulations.

FIG. 3 is a schematic showing the chemical structures of components used in the Example curable release formulations.

FIG. 4 is a photograph demonstrating an example master material with a surface having 3-dimensional structures thereon

FIG. 5 is a photograph demonstrating an example of an embossed ITM

FIG. 6 is a photograph demonstrating an example structured image (hologram) on a print substrate formed by an example electrostatic printing method described herein.

### DETAILED DESCRIPTION

Before the electrostatic printing method for forming a structured image on a print substrate, the method for forming an embossed intermediate transfer member and the embossed intermediate transfer member are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “liquid carrier”, “carrier liquid,” “carrier,” or “carrier vehicle” refers to the fluid in which the polymers, particles, colorant, charge directors and other additives can be dispersed to form a liquid electrophotographic ink or electrostatic ink. Such carrier liquids and vehicle components are known in the art. Typical carrier liquids can include a mixture of a variety of different agents, such as surfactants, co-solvents, viscosity modifiers, and/or other possible ingredients.

As used herein, “electrostatic” generally refers to an ink composition that is typically suitable for use in an electrostatic printing process, sometimes termed an electrophotographic printing process, or liquid electrophotographic printing process. The electrostatic ink composition may include chargeable particles of the resin and the pigment dispersed in a liquid carrier, which may be as described herein. The electrostatic ink may also comprise a charge director or adjuvant as may be described herein.

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photoimaging plate either directly or indirectly via an intermediate transfer member to a print substrate. Electrostatic printing processes typically involve creating an image on a photoconductive surface, applying an ink having charged particles to the photoconductive surface, such that they selectively bind to the image, and then transferring the charged particles in the form of the image, either directly or indirectly via an intermediate transfer member, to a print substrate. The photoconductive surface may be on a cylinder and is often termed a photo imaging plate (PIP). The photoconductive surface is selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image can be transferred to an intermediate transfer member, which may be a soft swelling blanket, before being transferred to the print substrate. In the examples described herein, the image is transferred to an embossed intermediate transfer member before being transferred to the print substrate.

As such, the image is not substantially absorbed into the photoimaging plate on which it is applied. Additionally, “electrostatic printers” or “electrophotographic printers” generally refer to those printers capable of performing electrostatic printing or electrophotographic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g., an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

As used herein, the term “comprises” has an open meaning, which allows other, unspecified features to be present. This term embraces, but is not limited to, the semi-closed term “consisting essentially of” and the closed term “consisting of”. Unless the context indicates otherwise, the term “comprises” may be replaced with either “consisting essentially of” or “consists of”.

Unless otherwise stated, any feature described herein can be combined with any aspect or any other feature described herein.

As used herein, a “structured image” refers to an image with a 3-dimensional structure. A structured image may be defined by at least one surface feature(s).

As used herein, “surface feature(s)” refer to any deviations (e.g. peaks and valleys) from a reference line (which may also be referred to as a mean line) that is traverse to a surface.

As used herein, “nanostructured” or “nanostructures” refers to a 3-dimensional structure with nanoscale surface features (i.e. in any direction). Nanoscale may refer to dimensions between 0.1 and 100 nm. The surface features may be measured using any suitable profilometer, for example, using atomic force microscopy.

As used herein, “microstructured” or “microstructures” refers to a 3-dimensional structure with microscale surface features (i.e. in any direction). Microscale may refer to dimensions between 0.25 and 999 μm. The surface features may be measured using any suitable profilometer, for example, using atomic force microscopy.

As used herein, the surface roughness “Ra”, is the arithmetic mean average of the height of surface features, measured from the reference line. Ra may be calculated using the formula:

$$R a = ( 1 / L ) {\int }_{0}^{{L}^{-}} \vert Z ( x ) \vert d x$$

wherein L is the evaluation length and Z is the height of surface features. In some examples, the Ra is calculated on a 100 μm×100 μm scale. The Ra may be determined using any suitable profilometer, for example, using atomic force microscopy.

As used herein, the surface roughness “Rq”, is the root mean square average of the height of surface features, measured from the reference line. Rq may be calculated using the formula:

Rq=[(1/L)∫₀^{L}Z(x)²dx]^{1/2}

wherein L is the evaluation length and Z is the height of surface features. In some examples, the Rq is calculated on a 100 μm×100 μm scale. Rq may otherwise be referred to as the room mean squared or RMS. The Rq may be determined using any suitable profilometer, for example, using atomic force microscopy.

As used herein, a “hologram” refers to a type of structured image that uses light diffraction to form an image. A hologram may have a nanostructure.

As used herein, a “watermark” refers to a type of structured image or pattern on a substrate that appears lighter or darker than the surrounding substrate when viewed with light. A watermark may have a microstructure.

As used herein, “embossed intermediate transfer member” refers to an intermediate transfer member with a structured surface. The structured surface may be in the form of a raised pattern, design or image. An embossed intermediate transfer member may be any intermediate transfer member capable of forming a structured image on a printed surface, for example, using electrostatic printing.

As used herein, the “substrate layer” of the ITM may be used interchangeably with “blanket body” As used herein, “image” in reference to a “structured image” may refer to any pattern, design, logo or image.

As used herein, “UV-A” in reference to light or radiation may refer to electromagnetic radiation having a wavelength in the range of about 315 nm to about 410 nm, for example about 320 nm to about 410 nm, about 340 nm to about 410 nm, about 340 nm to about 400 nm, about 360 nm to about 410 nm, about 365 nm to about 405 nm, about 365 to about 400 nm, or about 395 nm. The term “UV-A source” refers to is a source of UV-A radiation, for example UV-20 LED.

As used herein, “UV photoinitiator” refers to a photoinitiator or photo-catalyst that is activatable on exposure to “UV radiation.” As used herein, “UV-A photoinitiator” refers to a photoinitiator or photo-catalyst that is activatable on exposure to “UV-A radiation.” Such UV-A photoinitiators are available commercially, an example is QPI-3100 (available from Polymer-G, Israel) which is designed for curing under UV-A with a wavelength of 395 nm (UV-LED at 395 nm).

As used herein, “transition metal hydrosilylation catalyst” refers to any catalyst that is capable of catalysing a hydrosilylation reaction. “Hydrosilylation” refers to the addition of silicon and hydrogen across unsaturated bonds, for example, C═C bonds.

In some examples, there is provided an electrostatic printing method for forming a structured image on a print substrate, the method comprising:

providing an electrostatic ink composition;

contacting the electrostatic ink composition with a latent electrostatic image on a photoconductive surface to create a developed toner image;

transferring the developed toner image to an embossed intermediate transfer member to create a structured toner image; and;

transferring the structured toner image to a print substrate.

In some examples, there is provided a method of forming an embossed intermediate transfer member for use in electrostatic printing, the method comprising:

providing i) a substrate layer, at least part of which is compressible and comprises an electrically conductive species and ii) a layer of curable release formulation disposed on the substrate layer;

contacting a the curable release formulation with the surface of a master material, the surface having 3-dimensional structures thereon;

curing the release formulation to form an outer release layer comprising a structured surface disposed on the substrate layer; and

removing the master material.

The method of forming an embossed intermediate transfer member may be used to produce the embossed intermediate transfer members described herein.

In some examples, there is provided an embossed intermediate transfer member for use in electrostatic printing, the intermediate transfer member comprising:

a substrate layer, at least part of which is compressible and comprises an electrically conductive species; and;

an outer release layer disposed on the substrate layer, the outer release layer comprising a structured surface.

The embossed intermediate transfer member may be used in the electrostatic printing methods described herein. The embossed intermediate transfer member may be producible by the method of forming the embossed intermediate transfer member described herein.

The present inventors found that the electrostatic printing method described herein could be used to form structured images, including, holograms and watermarks. This was possible by utilising an embossed intermediate transfer member (ITM) during electrostatic printing. The embossed ITM may comprise a structured surface. The developed toner image can be formed on the structured surface of the embossed ITM (e.g. by depositing particles comprising a resin and a pigment, as described herein and causing the particles to soften and/or melt into a coherent layer on the embossed ITM) to form a structured toner image, the structured surface having a mirrored structure to that of the structured toner image. The structured toner image could then be transferred to a print substrate. This was achievable despite the presence of a carrier fluid in electrostatic inks, which was expected to cause the ITM to swell, causing a loss of structure. The resultant structured image was also well-defined on the print substrate, despite the application of pressure and/or heat during the electrostatic printing process. Structured images printed with darker electrostatic inks, e.g. black or cyan electrostatic inks, were found to improve the visual result. Structured images formed from more than one layer of ink transferred to the embossed ITM, were also found to improve the visual result.

The method of forming structured images on a substrate herein may reduce the number of production steps compared to previous methods in the art. For example, the method of forming structured images on a substrate herein may not comprise additional stamping, or the addition of holographic or watermarked material, after printing an image. The method of forming structured images described herein may also be faster compared to other methods in the art, for example methods involving using lasers to form a holographic image. The method allows the mass production of substrates with watermark or holographic images on them. The method of forming structured images on a print substrate herein can also be used to generate authentication marks on the intermediate transfer member itself (on an area not used for printing), which can be used to increase consumer confidence.

The embossed ITM described herein could be produced when forming the outer release layer on the substrate layer of the ITM (otherwise referred to as the “blanket body”). The method of forming the embossed ITM is therefore compatible with the chemistry used for forming the outer release layer. It was found that a curable release formulation could be disposed on the substrate layer and then contacted with a master material, the master material having 3 dimensional structures thereon. The curable release formulation could then be cured to form an outer release layer comprising a structured surface. After curing, the master material could be removed without distorting the structured surface formed on the cured release layer.

Embossed Intermediate Transfer Member (ITM)

The embossed intermediate transfer member may be termed an embossed ITM herein for brevity. The embossed ITM is suitable for use in electrostatic printing. The embossed ITM comprises any suitable material such that a developed toner image can be transferred from the photoconductive surface onto the embossed ITM during electrostatic printing. The embossed ITM may be electrically conductive. The embossed ITM may have a cylindrical shape, as such the embossed ITM may be suitable for use as a roller, for example a roller in an electrostatic printing apparatus.

The embossed intermediate transfer member herein may comprise a structured surface. The structured surface may be capable of forming a structured toner image, the structured surface having a mirrored structure to that of the structured toner image. The structured toner image may then be transferred to a print substrate to form a structured image. In some examples, the structured image is a hologram or a watermark, in other words, the structured toner image is transferred to a print substrate to form a hologram or a watermark.

In some examples, the structured surface is a nanostructured surface, for example, a holographic nanostructured surface. The nanostructured surface may be suitable for forming a hologram, for example, by creating a holographic structured toner image on the embossed ITM which may be transferred to the print substrate to form a hologram. In some examples, the nanostructured surface may comprise surface features with a height of from 0.1 to 100 nm, or from 1 nm to 75 nm, or from 3 nm to 60 nm, or from 5 nm to 50 nm, or from 10 nm to 40 nm. In some examples, the nanostructured surface may comprise surface features with a height of less than 100 nm, or less than 90 nm, or less than 80 nm, or less than 70 nm, or less than 60 nm, or less than 50 nm, or less than 40 nm. In some examples, the nanostructured surface may comprise surface features with a mean surface roughness (Rₐ) from 0.1 to 100 nm, or from 1 nm to 75 nm, or from 3 nm to 60 nm, or from 5 nm to 50 nm, or from 10 nm to 40 nm. In some examples, the nanostructured surface may comprise surface features with a mean surface roughness (Rₐ) of less than 100 nm, or less than 90 nm, or less than 80 nm, or less than 70 nm, or less than 60 nm, or less than 50 nm, or less than 40 nm. In some examples, the nanostructured surface may comprise surface features with a root mean square surface roughness (R_{q}) from 0.1 nm to 100 nm, or from 1 nm to 75 nm, or from 3 nm to 60 nm, or from 5 nm to 50 nm, or from 10 nm to 40 nm. In some examples, the nanostructured surface may comprise surface features with a root mean square surface roughness (R_{q}) of less than 100 nm, or less than 90 nm, or less than 80 nm, or less than 70 nm, or less than 60 nm, or less than 50 nm, or less than 40 nm. The nanostructured surface may have any suitable pattern. The nanostructured surface may have a regular or an irregular pattern. The nanostructured surface may have a pattern selected from dots, repeating geometric shapes, spirals, prints, stripes, an image, letters, numbers, symbols, or any other pattern suitable for forming a hologram.

In some examples, the structured surface is a microstructured surface, for example, a watermark microstructured surface. The microstructured surface may suitable for forming a watermark, that is, by creating a watermarked structured toner image which may be transferred to the print substrate to form a watermark. The microstructured surface may comprise surface features with a height from 0.25 μm to 100 μm, or from 0.275 μm to 50 μm, or from 0.3 μm to 10 μm, or from 0.4 μm to 5.5 μm, or from 0.45 μm to 5.25 μm, or from 0.5 μm to 5 μm. The microstructured surface may comprise surface features with a mean surface roughness (Rₐ) from 0.25 μm to 100 μm, or from 0.3 μm to 50 μm, or from 0.4 μm to 10 μm, or from 0.5 μm to 5 μm. The microstructured surface may have surface features with a root mean square surface (R_{q}) roughness of from 0.25 μm to 100 μm, or from 0.3 μm to 50 μm, or from 0.4 μm to 10 μm, or from 0.5 μm to 5 μm. The microstructured surface may have any suitable pattern. The microstructured surface may have a regular or an irregular pattern. The microstructured surface may have a pattern selected from dots, repeating geometric shapes, spirals, prints, stripes, an image, letters, numbers, symbols, or any other pattern suitable for forming a watermark. In some examples, the microstructured surface comprises surface features that have dimensions less than the thickness of the outer release layer (i.e. in the same direction). In some examples, the microstructured surface comprises surface features that have dimensions at least 50% less than the thickness of the outer release layer (i.e. in the same direction), in some examples, at least 70% less, in some examples, at least 90% less.

In some examples, the embossed ITM comprises a substrate layer, at least part of which is compressible and comprises an electrically conductive species, and an outer release layer disposed on the substrate layer, the outer release layer comprising a structured surface.

Outer Release Layer

In some examples, the structured surface of the outer release layer is a nanostructured surface which may have surface features with surface dimensions as described herein, for example, a holographic nanostructured surface. The nanostructured surface may suitable for forming a hologram, for example, by creating a holographic structured toner image on the outer release layer which may be transferred to the print substrate to form a hologram.

In some examples, the structured surface of the outer release layer is a microstructured surface which may have surface features with surface dimensions as described herein, for example, a watermark microstructured surface. The microstructured surface may be suitable for forming a watermark, for example, by creating a watermark structured toner image on the outer release layer which may be transferred to the print substrate to form a watermark.

In some examples, the outer release layer has a thickness of at least 0.25 μm, or at least 0.5 μm, or at least 1 μm, or at least 1.25 μm, or at least 2 μm, or at least 3 μm, or at least 4 μm. In some examples, the outer release layer has a thickness of less than 50 μm, or less than 25 μm, or less than 10 μm.

In some examples, the outer release layer has a thickness of from 0.25 μm to about 15 μm, or from 0.5 μm to about 10 μm, or from 1 μm to about 8 μm, (e.g. suitable for forming a nanostructured surface). In some examples, the outer release layer has a thickness of from 1 μm to 1000 μm, or from about 1 μm to 50 μm, or from 1 μm to 25 μm (e.g. suitable for forming a microstructured surface).

The outer release layer may comprise any suitable material for electrostatic printing. In some examples, the outer release layer may comprise a polyurethane resin or a cured silicone. In an example, the outer release layer is a cured silicone release layer. For a cured silicone release layer, it is found that the structured surface remains well-defined despite i) the application of carrier fluid from the electrostatic ink during electrostatic printing method, and ii) any heat or pressure applied during the electrostatic printing method.

In some examples, the outer release layer is formed by curing a curable release formulation. The curable release formulation may be cured thermally or by irradiation with UV light, for example, UV-A light.

In some examples, the outer release layer is formed by curing a curable release formulation comprising a polyalkylsiloxane comprising at least two vinyl groups,

a polyalkylsiloxane crosslinker, and

at least one of a UV photoinitiator or a transition metal hydrosilylation catalyst.

In an example, the outer release layer is formed by UV curing a UV release formulation, comprising:

a polyalkylsiloxane comprising at least two vinyl groups,

a polyalkylsiloxane crosslinker, and

a UV photoinitiator.

In an example, the outer release layer is formed by thermal curing a thermal curable release formulation comprising:

a polyalkylsiloxane comprising at least two vinyl groups,

a polyalkylsiloxane crosslinker,

and a transition metal hydrosilylation catalyst.

Polyalkylsiloxane Comprising at Least Two Vinyl Groups

In some examples, the polyalkylsiloxane comprising at least two vinyl groups comprises a linear polyalkylsiloxane comprising at least two vinyl groups, a branched polyalkylsiloxane comprising at least two vinyl groups, a cyclic polyalkylsiloxane comprising at least two vinyl groups, or a combination thereof. In an example, the polyalkylsiloxane comprising at least two vinyl groups comprises a linear polyalkylsiloxane.

In some examples, the polyalkylsiloxane comprising at least two vinyl groups comprises polyalkylsiloxanes with terminal vinyl groups, pendant vinyl groups or a combination thereof.

In some examples, the polyalkylsiloxane comprising at least two vinyl groups may comprise a vinyl-terminated polyalkylsiloxane, which may have the following Formula (I):

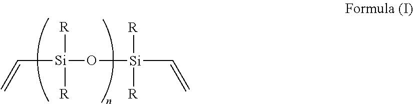

wherein

each R is independently selected from C1 to C6 alkyl, and n is 1 or more.

In some examples, each R is independently selected from C1, C2, C3, C4, C5 and C6 alkyl. In some examples, each R is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R is independently selected from methyl, ethyl, n-propyl, isopropyl, n-butyl, sec-butyl, isobutyl, and tert-butyl. In some examples, each R is independently selected from methyl, ethyl, n-propyl, and isopropyl. In some examples, each R is the same. In some examples, each R is methyl.

In some examples, n is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, n is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less, in some examples, 2 or less. In some examples, n is 1 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, the vinyl-terminated polyalkylsiloxane has a viscosity at 25° C. of 250 mPa-s or more, in some examples, 300 mPa-s or more, in some examples, 350 mPa-s or more, in some examples, 400 mPa-s or more, in some examples, 450 mPa-s or more, in some examples, 500 mPa-s or more, in some examples, 550 mPa-s or more, in some examples 600 mPa-s or more, in some examples, 650 mPa-s or more, in some examples, 700 mPa-s or more, in some examples, about 750 mPa-s. In some examples, the vinyl-terminated polyalkylsiloxane has a viscosity at 25° C. or 750 mPa-s or less, in some examples, 700 mPa-s or less, in some examples, 650 mPa-s or less, in some examples, 600 mPa-s or less, in some examples, 550 mPa-s or less, in some examples, 500 mPa-s or less, in some examples, 450 mPa-s or less, in some examples, 400 mPa-s or less, in some examples, 350 mPa-s or less, in some examples, 300 mPa-s or less, in some examples, about 250 mPa-s. In some examples, the vinyl-terminated polyalkylsiloxane has a viscosity at 25° C. of 250 mPa-s to 750 mPa-s, in some examples, 300 mPa-s to 700 mPa-s, in some examples, 350 mPa-s to 650 mPa-s, in some examples, 400 mPa-s to 600 mPa-s, in some examples, 450 mPa-s to 550 mPa-s, in some examples, 450 mPa-s to 500 mPa-s.

In some examples, the vinyl-terminated polyalkylsiloxane may have a vinyl content of 0.05 mmol/g or more, in some examples, 0.06 mmol/g or more, in some examples, 0.07 mmol/g or more, in some examples, 0.08 mmol/g or more, in some examples, 0.09 mmol/g or more, in some examples, 0.1 mmol/g or more, in some examples, 0.11 mmol/g or more, in some examples, 0.12 mmol/g or more, in some examples, 0.13 mmol/g or more, in some examples, 0.14 mmol/g or more, in some examples, 0.15 mmol/g or more, in some examples, 0.16 mmol/g or more, in some examples, 0.17 mmol/g or more, in some examples, 0.18 mmol/g or more, in some examples, 0.19 mmol/g or more, in some examples, 0.2 mmol/g or more, in some examples, 0.3 mmol/g or more, in some examples, 0.4 mmol/g or more, in some examples, 0.5 mmol/g or more, in some examples, about 0.6 mmol/g. In some examples, the vinyl-terminated polyalkylsiloxane may have a vinyl content of 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.19 mmol/g or less, in some examples, 0.18 mmol/g or less, in some examples, 0.17 mmol/g or less, in some examples, 0.16 mmol/g or less, in some examples, 0.15 mmol/g or less, in some examples, 0.14 mmol/g or less, in some examples, 0.13 mmol/g or less, in some examples, 0.12 mmol/g or less, in some examples, 0.11 mmol/g or less, in some examples, 0.1 mmol/g or less, in some examples, 0.09 mmol/g or less, in some examples, 0.08 mmol/g or less, in some examples, 0.07 mmol/g or less, in some examples, 0.06 mmol/g or less, in some examples, about 0.05 mmol/g. In some examples, the vinyl-terminated polyalkylsiloxane may have a vinyl content of 0.05 mmol/g to 0.6 mmol/g, in some examples, 0.06 mmol/g to 0.5 mmol/g, in some examples, 0.07 mmol/g to 0.4 mmol/g, in some examples, 0.08 mmol/g to 0.3 mmol/g, in some examples, 0.09 mmol/g to 0.2 mmol/g, in some examples, 0.1 mmol/g to 0.19 mmol/g, in some examples, 0.11 mmol/g to 0.18 mmol/g, in some examples, 0.12 mmol/g to 0.17 mmol/g, in some examples, 0.13 mmol/g to 0.16 mmol/g, in some examples, 0.14 mmol/g to 0.15 mmol/g.

In some examples, the polyalkylsiloxane comprising at least two vinyl groups may comprise a pendent-vinyl polyalkylsiloxane, which may have the following Formula (II):

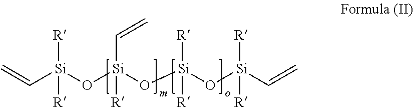

Wherein each R′ is independently selected from C1 to C6 alkyl, m is 1 or more, and o is 0 or more.

In some examples, each R′ is independently selected from C1, C2, C3, C4, C5 and C6 alkyl.

In some examples, each R′ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′ is independently selected from methyl, ethyl, n-propyl, isopropyl, n-butyl, sec-butyl, isobutyl, and tert-butyl. In some examples, each R′ is independently selected from methyl, ethyl, n-propyl, and isopropyl. In some examples, each R′ is the same. In some examples, each R′ is methyl.

In some examples, m is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, m is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples 5 or less. In some examples, m is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, o is 0 or more, in some examples, 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, o is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less. In some examples, o is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, the pendent vinyl polyalkylsiloxane has a viscosity at 25° C. of 2500 mPa-s or more, in some examples, 2550 mPa-s or more, in some examples, 2600 mPa-s or more, in some examples, 2650 mPa-s or more, in some examples, 2700 mPa-s or more, in some examples, 2750 mPa-s or more, in some examples, 2800 mPa-s or more, in some examples 2900 mPa-s or more, in some examples, 3000 mPa-s or more, in some examples, 3050 mPa-s or more, in some examples, 3100 mPa-s or more, in some examples, 3150 mPa-s or more, in some examples, 3200 mPa-s or more, in some examples, 3250 mPa-s or more, in some examples, 3300 mPa-s or more, in some examples, 3350 mPa-s or more, in some examples, 3400 mPa-s or more, in some examples, 3450 mPa-s or more, in some examples, about 3500 mPa-s. In some examples, the pendent vinyl polyalkylsiloxane has a viscosity at 25° C. or 3500 mPa-s or less, in some examples, 3450 mPa-s or less, in some examples, 3400 mPa-s or less, in some examples, 3350 mPa-s or less, in some examples, 3300 mPa-s or less, in some examples, 3250 mPa-s or less, in some examples, 3200 mPa-s or less, in some examples, 3150 mPa-s or less, in some examples, 3100 mPa-s or less, in some examples, 3050 mPa-s or less, in some examples, 3000 mPa-s or less, in some examples, 2950 mPa-s or less, in some examples, 2900 mPa-s or less, in some examples, 2850 mPa-s or less, in some examples, 2800 mPa-s or less, in some examples, 2750 mPa-s or less, in some examples, 2700 mPa-s or less, in some examples, 2650 mPa-s or less, in some examples, about 2500 mPa-s. In some examples, the pendent vinyl polyalkylsiloxane has a viscosity at 25° C. of 2500 mPa-s to 3500 mPa-s, in some examples, 2550 mPa-s to 3450 mPa-s, in some examples, 2600 mPa-s to 3400 mPa-s, in some examples, 2650 mPa-s to 3350 mPa-s, in some examples, 2700 mPa-s to 3300 mPa-s, in some examples, 2750 mPa-s to 3250 mPa-s, in some examples, 2800 mPa-s to 3200 mPa-s, in some examples, 2850 mPa-s to 3150 mPa-s, in some examples, 2900 mPa-s to 3100 mPa-s, in some examples, 2950 mPa-s to 3050 mPa-s, in some examples, 3000 mPa-s to 3050 mPa-s.

In some examples, the pendent vinyl polyalkylsiloxane may have a vinyl content of 0.1 mmol/g or more, 0.2 mmol/g or more, in some examples, 0.3 mmol/g or more, in some examples, 0.4 mmol/g or more. In some examples, the vinyl-terminated polyalkylsiloxane may have a vinyl content of 2 mmol/g or less, in some examples, 1 mmol/g or less, in some examples, 0.9 mmol/g or less, in some examples, 0.8 mmol/g or less, in some examples, 0.7 mmol/g or less, in some examples, 0.6 mmol/g or less, in some examples, 0.5 mmol/g or less, in some examples, 0.4 mmol/g or less. In some examples, the vinyl-terminated polyalkylsiloxane may have a vinyl content of 0.1 mmol/g to 2 mmol/g, in some examples, 0.2 mmol/g to 1 mmol/g, in some examples, 0.3 mmol/g to 0.9 mmol/g, in some examples, 0.4 mmol/g to 0.8 mmol/g, in some examples, 0.5 mmol/g to 0.7 mmol/g, in some examples, 0.3 mmol/g to 0.6 mmol/g.

In some examples, the polyalkylsiloxane comprising at least two vinyl groups comprises both a vinyl-terminated polyalkylsiloxane and a pendent vinyl polyalkylsiloxane. In some examples, the polyalkylsiloxane comprising at least two vinyl groups comprises both a vinyl-terminated polyalkylsiloxane of Formula (I) and a pendent-vinyl polyalkylsiloxane of Formula (II), wherein R, R′, n, m and o may be as described herein.

In some examples, the polyalkylsiloxane comprising at least two vinyl groups comprises a mixture of vinyl-terminated polyalkylsiloxane (e.g. Formula (I)) and pendent vinyl polyalkylsiloxane (e.g. Formula (II)) in a ratio of from 1:10 to 10:1. In some examples, the polyalkylsiloxane comprising at least two vinyl groups comprises a mixture of vinyl-terminated polyalkylsiloxane and pendent vinyl polyalkylsiloxane in a ratio of from 1:9 to 9:1 mixture, in some examples, from 1:8 to 8:1, in some examples, from 1:7 to 7:1, in some examples, from 1:6 to 6:1, in some examples, from 1:5 to 5:1, in some examples, from 1:4 to 4:1, in some examples, from 1:3 to 3:1, in some examples, from 1:2 to 2:1, in some examples, from 1:1 to 4:1.

Suitable examples of vinyl-terminated polyalkylsiloxanes, e.g. of Formula (I), include Polymer VS 50, Polymer VS 100, Polymer VS 200, Polymer VS 500, Polymer VS 1000, Polymer VS 2000.

Suitable examples of pendent vinyl polyalkylsiloxanes, e.g. of Formula (II), include Polymer RV 100, Polymer RV 200, Polymer RV 5000.

Other suitable examples of polyalkylsiloxane comprising at least two vinyl groups include DMS-V00, DMS-V03, DMS-V05, DMS-V21, DMS-V22, DMS-V25, DMS-V31, DMS-V33, DMS-V34, DMS-V35, DMS-V41, DMS-V42, DMS-V43, DMS-V46, DMS-V51, DMS-V52 from Gelest Inc, Stroofstrasse 27, Geb.2901, 65933 Frankfurt am Main, Germany).

Polyalkylsiloxane Crosslinker

In some examples, the polyalkylsiloxane crosslinker comprises at least one Si—H group, and in some examples, at least two Si—H groups. In some examples, the polyalkylsiloxane crosslinker is selected from a linear polyalkylsiloxane crosslinker, a branched polyalkylsiloxane crosslinker and a cyclic polyalkylsiloxane crosslinker. In some examples, the polyalkylsiloxane crosslinker is a linear polyalkylsiloxane crosslinker.

In some examples, the polyalkylsiloxane comprising at least one Si—H bonds comprises a polyalkylsiloxane cross-linker having the Formula (III)

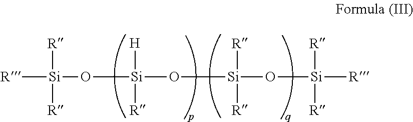

wherein each R″ is independently selected from C1 to C6 alkyl; each R′″ is independently selected from H and C1 to C6 alkyl; p is 2 or more; and q is 0 or more.

In some examples, each R″ is independently selected from C1, C2, C3, C4, C5 and C6 alkyl. In some examples, each R″ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-ethylbutyl, pentan-2-yl, and pentan-3-yl. In some examples, each R″ is independently selected from methyl, ethyl, n-propyl, isopropyl, n-butyl, sec-butyl, isobutyl, and tert-butyl. In some examples, each R″ is independently selected from methyl, ethyl, n-propyl, and isopropyl. In some examples, each R″ is the same. In some examples, each R″ is methyl.

In some examples, each R′″ is independently selected from H, C1, C2, C3, C4, C5 and C6 alkyl. In some examples, each R′″ is independently selected from H, methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′″ is independently selected from H, methyl, ethyl, n-propyl, isopropyl, n-butyl, sec-butyl, isobutyl, and tert-butyl. In some examples, each R′″ is independently selected from H, methyl, ethyl, n-propyl, and isopropyl. In some examples, each R′″ is the same. In some examples, each R′″ is methyl or H. In some examples, each R′″ is H.

In some examples, p is 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, p is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less. In some examples, p is 2 to 50, in some examples, 3 to 10, in some examples, 4 to 9, in some examples, 5 to 8, in some examples, 6 to 7.

In some examples, q is 0 or more, in some examples, 1 or more, in some examples, 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, q is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less, in some examples, 1 or less. In some examples, q is 0 to 50, in some examples, 1 to 10, in some examples, 2 to 9, in some examples, 3 to 8, in some examples, 4 to 7, in some examples, 5 to 6.

In some examples, the polyalkylsiloxane cross-linker comprising at least one Si—H group may be a random copolymer, a block copolymer, an alternating copolymer or a periodic copolymer. In some examples, the polyalkylsiloxane cross-linker comprising at least one Si—H group may be a random copolymer.

In some examples, the polyalkylsiloxane cross-linker comprising at least one Si—H group has a viscosity at 25° C. of 5 mPa-s or more, in some examples, 10 mPa-s or more, in some examples, 15 mPa-s or more, in some examples, 20 mPa-s or more, in some examples, 25 mPa-s or more, in some examples, 30 mPa-s or more, in some examples, 35 mPa-s or more, in some examples 40 mPa-s or more, in some examples, 45 mPa-s or more, in some examples, 50 mPa-s or more, in some examples, 55 mPa-s or more, in some examples, 60 mPa-s or more, in some examples, 65 mPa-s or more, in some examples, 70 mPa-s or more, in some examples, 75 or more, in some examples, about 80 mPa-s. In some examples, the polyalkylsiloxane cross-linker has a viscosity at 25° C. or 80 mPa-s or less, in some examples, 75 mPa-s or less, in some examples, 70 mPa-s or less, in some examples, 65 mPa-s or less, in some examples, 60 mPa-s or less, in some examples, 55 mPa-s or less, in some examples, 50 mPa-s or less, in some examples, 45 mPa-s or less, in some examples, 40 mPa-s or less, in some examples, 35 mPa-s or less, in some examples, 30 mPa-s or less, in some examples, 25 mPa-s or less, in some examples, 20 mPa-s or less, in some examples, 15 mPa-s or less, in some examples, about 10 mPa-s. In some examples, the polyalkylsiloxane cross-linker has a viscosity at 25° C. of 10 mPa-s to 80 mPa-s, in some examples, 15 mPa-s to 75 mPa-s, in some examples, 20 mPa-s to 70 mPa-s, in some examples, 25 mPa-s to 65 mPa-s, in some examples, 30 mPa-s to 60 mPa-s, in some examples, 35 mPa-s to 55 mPa-s, in some examples, 40 mPa-s to 50 mPa-s, in some examples, 40 mPa-s to 45 mPa-s.

In some examples, the polyalkylsiloxane cross-linker comprising at least one Si—H group may have an Si—H content of 1 mmol/g or more, in some examples, 2 mmol/g or more, in some examples, 3 mmol/g or more, in some examples, 3.5 mmol/g or more, in some examples, 4 mmol/g or more, in some examples, 4.1 mmol/g or more, in some examples, 4.2 mmol/g or more, in some examples, 4.3 mmol/g or more, in some examples, 4.5 mmol/g or more, in some examples, 5 mmol/g or more, in some examples, 6 mmol/g or more, in some examples, 7 mmol/g or more, in some examples, about 8 mmol/g. In some examples, the polyalkylsiloxane cross-linker may have an Si—H content of 8 mmol/g or less, in some examples, 7 mmol/g or less, in some examples, 6 mmol/g or less, in some examples, 5 mmol/g or less, in some examples, 4.5 mmol/g or less, in some examples, 4.4 mmol/g or less, in some examples, 4.3 mmol/g or less, in some examples, 4.2 mmol/g or less, in some examples, 4.1 mmol/g or less, in some examples, 4 mmol/g or less, in some examples, 3.5 mmol/g or less, in some examples, 3 mmol/g or less, in some examples, 2 mmol/g or less, in some examples, about 1 mmol/g. In some examples, the polyalkylsiloxane cross-linker may have an Si—H content of 1 mmol/g to 8 mmol/g, in some examples, 2 mmol/g to 7 mmol/g, in some examples, 3 mmol/g to 6 mmol/g, in some examples, 3.5 mmol/g mmol/g to 5 mmol/g, in some examples, 4 mmol/g to 4.5 mmol/g, in some examples, 4.1 mmol/g to 4.4 mmol/g, in some examples, 4.2 mmol/g to 4.3 mmol/g.

Suitable examples of the polyalkylsiloxane cross-linker, e.g. of Formula (III), include Cross-linker 200, Cross-linker 210, Cross-linker 100, Cross-linker 101, Cross-linker 120, Cross-linker 125 or Cross-linker 190, available from Evonik Industries. Other suitable crosslinkers include HMS-031, HMS-071, HMS-082, HMS-013, and HMS-064 from Gelest Inc., Stroofstrasse 27, Geb.2901, 15 65933 Frankfurt am Main, Germany).

In some examples, the curable release formulation comprises a ratio of polyalkylsiloxane cross-linker comprising at least one Si—H group to polyalkylsiloxane comprising at least two vinyl groups such that the mole ratio of hydride to vinyl is from 4:1 to 1:4. In some examples, the mole ratio of hydride to vinyl is from 3:1 to 1:3, in some examples, 2.5:1 to 1:2.5, in some examples, 2:1 to 1:2, in some examples, 2:1 to 1:1, in some examples, about 2:1, for example, 2.1:1.

In some examples, the curable release formulation comprises a weight ratio of polyalkylsiloxane cross-linker comprising at least one Si—H group to polyalkylsiloxane comprising at least two vinyl groups of from 1:20 to 1:1, in some examples, 1:19 to 1:2, in some examples, 1:18 to 1:3, in some examples, 1:17 to 1:4, in some examples, 1:16 to 1:5, in some examples, 1:15 to 1:6, in some examples, 1:14 to 1:7, in some examples, 1:13 to 1:8, in some examples, 1:12 to 30 1:9, in some examples, 1:11 to 1:10.

UV-A Photoinitiator

In some examples, the curable release formulation comprises a UV photoinitiator. In some examples, the curable release formulation is a UV-curable release formulation that comprises a UV photoinitiator. A UV photoinitiator is a photoinitiator or photo-catalyst that is activatable on exposure to UV radiation, which are is designed for curing under UV with a wavelength of from 200 nm to 400 nm. In some examples, the UV photoinitiator is a UV-A photoinitiator. A UV-A photoinitiator is a photoinitiator or photo-catalyst that is activatable on exposure to UV-A radiation. UV-A photoinitiators are available commercially, an example is QPI-3100 (available from Polymer-G, Israel) which is designed for curing under UV-A with a wavelength of 395 nm (UV-LED at 395 nm). On activation of the UV-A photoinitiator on exposure to UV-A radiation, the UV-A photoinitiator initiates curing reaction of the polyalkylsiloxane comprising at least two vinyl groups and the polyalkylsiloxane cross-linker.

In some examples, the curable release formulation may comprise, by total weight of the formulation, 2000 ppm or less of a UV photoinitiator, in some examples, 1500 ppm or less, in some examples, 1000 ppm or less, in some examples, 500 ppm or less, in some examples, 250 ppm or less, in some examples, 200 ppm or less, in some examples, 150 ppm or less, in some examples, 100 ppm or less, in some examples, 95 ppm or less, in some examples, 90 ppm or less, in some examples, 85 ppm or less, in some examples, 80 ppm or less, in some examples, 75 ppm or less, in some examples, 70 ppm or less, in some examples, 65 ppm or less, in some examples, 60 ppm or less, in some examples, 55 ppm or less, in some examples, 50 ppm or less of a UV photoinitiator. In some examples, the curable release formulation may comprise (by total weight of the formulation) 1 ppm or more of a UV photoinitiator, in some examples, 5 ppm or more, in some examples, 10 ppm or more, in some examples, 15 ppm or more, in some examples, 20 ppm or more, in some examples, 25 ppm or more of a UV photoinitiator. In some examples, the curable release formulation may comprise (by total weight of the composition) 1 ppm to 2000 ppm of a UV photoinitiator, in some examples, 1 ppm to 1000 ppm, in some examples, 5 ppm to 500 ppm, in some examples, 10 ppm to 250 ppm, in some examples, 10 ppm to 100 ppm, in some examples, 20 ppm to 75 ppm, in some examples, 25 ppm to 60 ppm, in some examples, 30 ppm to 55 ppm, in some examples, 40 ppm to 50 ppm of a UV photoinitiator.

In some examples, the curable release formulation is a thermal curable release formulation which is free of UV photoinitiator.

Transition Metal Hydrosilylation Catalyst

In some examples, the curable release formulation comprises a transition metal hydrosilylation catalyst. In some examples, the curable release formulation is a thermal curable release formulation which comprises a transition metal hydrosilylation catalyst. The transition metal hydrosilylation catalyst may be any suitable catalyst for catalysing a hydrosilylation reaction. In some examples, the transition metal hydrosilylation catalyst comprises a transition metal selected from Pt(0), Rh(I) or Ru(2).

In some examples, the curable release formulation may comprise, by total weight of the formulation, 2000 ppm or less of transition metal, wherein the transition metal derives from the transition metal hydrosilylation catalyst, in some examples, 1500 ppm or less, in some examples, 1000 ppm or less, in some examples, 500 ppm or less, in some examples, 250 ppm or less, in some examples, 200 ppm or less, in some examples, 150 ppm or less, in some examples, 100 ppm or less, in some examples, 95 ppm or less, in some examples, 90 ppm or less, in some examples, 85 ppm or less, in some examples, 80 ppm or less, in some examples, 75 ppm or less, in some examples, 70 ppm or less, in some examples, 65 ppm or less, in some examples, 60 ppm or less, in some examples, 55 ppm or less, in some examples, 50 ppm or less of a transition metal, in some examples, 30 ppm or less of a transition metal, in some examples, 20 ppm or less of a transition metal, wherein the transition metal derives from the transition metal hydrosilylation catalyst. In some examples, the curable release formulation may comprise (by total weight of the formulation) 1 ppm or more of a transition metal, wherein the transition metal derives from the transition metal hydrosilylation catalyst, in some examples, 5 ppm or more, in some examples, 10 ppm or more, in some examples, 15 ppm or more, in some examples, 20 ppm or more, of a transition metal, wherein the transition metal derives from the transition metal hydrosilylation catalyst. In some examples, the curable release formulation may comprise (by total weight of the composition) 1 ppm to 2000 ppm of transition metal wherein the transition metal derives from the transition metal hydrosilylation catalyst, in some examples, 1 ppm to 1000 ppm, in some examples, 5 ppm to 500 ppm, in some examples, 6 ppm to 250 ppm, in some examples, 7 ppm to 100 ppm, in some examples, 8 ppm to 75 ppm, in some examples, 10 ppm to 60 ppm, in some examples, from 5 ppm to 50 ppm, in some examples, 15 ppm to 40 ppm of transition metal, wherein the transition metal derives from the transition metal hydrosilylation catalyst. In some examples, the transition metal is platinum.

In some examples, the transition metal hydrosilylation catalyst comprises a platinum(0) catalyst. In some examples, the platinum (0) catalyst is a vinyl siloxane platinum (0) complex. In some examples, the platinum (0) catalyst is selected from divinyltetramethyl disiloxane platinum (0) complex, (otherwise referred to as Karsdtedt's catalyst) or a platinum(0)-2,4,6,8-tetramethyl-2,4,6,8-tetravinylcyclotetrasiloxane complex. In an example, the transition metal hydrosilylation catalyst is divinyltetramethyl disiloxane platinum (0) complex.

Suitable examples of commercial transition metal hydrosilylation catalysts include Catalyst 510, Catalyst 511, Catalyst 512, Catalyst 517 and Catalyst 540 from Evonik Hanse GmBH.

Conductive Particles

In some examples, the curable release formulation further comprises conductive particles. The conductive particles may be added such that the outer release layer of the embossed ITM is partially conductive. In some examples, the conductive particles may be electrically conductive particles. In some examples, the conductive particles may comprise carbon black. In some examples, the carbon black may be or comprise carbon black nanotubes or carbon black nanoparticles. In some examples, the carbon black nanoparticles have a BET surface area of 700 m²/g or greater, or 1000 m²/g or greater, or 1200 m²/g or greater, or 1300 m²/g or greater, or 1400 m²/g or greater. The BET surface area of the carbon black nanoparticles may be determined according to ASTM Standard D6556-14.

In some examples, the mean primary particle diameter of the carbon black nanoparticles is about 42 nm or less, in some examples about 40 nm or less, in some examples about 38 nm or less, in some examples about 36 nm or less, in some examples about 35 nm or less, in some examples about 34 nm or less. The mean particle diameter of carbon black nanoparticles may be determined according to ASTM standard D3849.

In some examples, the curable release formulation may comprise 0.01 wt. % to 10 wt. % conductive particles, in some examples, 0.02 wt. % to 9 wt. %, in some examples, 0.05 wt. % to 8 wt. %, in some examples, 0.1 wt. % to 7 wt. %, in some examples, 0.2 wt. % to 6 wt. %, in some examples, 0.25 wt. % to 4 wt. %, in some examples, 0.3 wt. % to 3 wt. %, in some examples, 0.35 wt. % to 2 wt. %, in some examples, 0.4 wt. % to 1.5 wt. %, in some examples, 0.5 wt. % to 1.2 wt. %, in some examples, 0.6 wt % to 1.1 wt % by total weight of the formulation. In some examples, the curable release formulation may comprise less than 10 wt. % conductive particles, or less than 9 wt. %, or less than 8 wt. %, or less than 7 wt. %, or less than 6 wt. %, or less than 5 wt. %, or less than 4 wt. %, or less than 3 wt. %, or less than 2 wt. %, or less than 1 wt. % conductive particles.

Suitable examples of the conductive particles include carbon black particles from AkzoNobel under the name Ketjenblack® EC600JD.

Thermal Inhibitor

In some examples, the curable release formulation comprises a thermal inhibitor. In some examples, the thermal inhibitor comprises an acetylenic alcohol or an alkanol. In some examples, the thermal inhibitor may inhibit thermal curing of the curable release formulation at room temperature (e.g. from 20° C. to 25° C.).

In some examples, the thermal curable release formulation comprises 0.01 wt. % to 10 wt. % thermal inhibitor, in some examples, 0.1 wt. % to 9 wt. %, in some examples, 1 wt. % to 8 wt. %, in some examples, 2 wt. % to 7 wt. %, in some examples, 3 wt. % to 5.5 wt. %, in some examples, 4 wt. % to 5 wt. %. In some examples, the thermal curable release formulation may have a pot-life of at least 1 hour, or at least 2 hours, or at least 3 hours.

In some examples, the UV curable release formulation comprises 0.001 wt. % to 10 wt. % thermal inhibitor, in some examples, 0.001 wt. % to 5 wt. %, in some examples, 0.01 wt. % to 2.5 wt. %, in some examples, 0.01 wt. % to 2 wt. %, in some examples, 0.1 wt. % to 1 wt. % thermal inhibitor. The thermal inhibitor may be added to the UV release formulation to suppress unwanted premature reaction caused by Pt(0), which may be formed during high shear mixing. In some examples, the UV curable release formulation may be substantially free of thermal inhibitor.

Suitable examples of the thermal inhibitor include Inhibitor 600, Inhibitor 500 and Inhibitor 400 from Evonik.

Substrate Layer

The substrate layer comprises an electrically conductive species and at least a part which is compressible.

The electrically conductive species may be selected from carbon black, carbon nanotubes (e.g. single walled-carbon nanotubes), an ionic material, metallic particles, metallic fibres or a combination thereof. The substrate layer may comprise an electrically conductive species in an amount of at least 2 wt. %, or at least 5 wt. %, or at least 10 wt. %, or least 15 wt. % by weight of the substrate layer. The substrate layer may comprise an electrically conductive species in an amount of from 2 wt. % to 20 wt %, optionally 2 wt % to 15 wt %.

The compressible part may comprise any material with a large degree of compressibility. The compressible part may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). In an example, the compressible part comprises nitrile rubber (NBR).

In some examples, the compressible part includes small voids, which may be as a result of microspheres or blowing agents used in the formation of the compressible part. In some examples, the small voids comprise about 40 to about 60% by volume of the compressible part.

In some examples, the compressible part may be in the form of a compressible layer. In some examples, the compressible layer may have a thickness from 400 μm to 900 μm, or from 500 μm to 750 μm, or from 550 μm to 650 μm, or about 600 μm.

In some examples, the substrate layer may be formed from a plurality of layers. For example, the substrate layer may comprise a compressible layer which comprises the compressible part and/or a conductive layer comprising the electrically conductive species. The substrate layer may comprise a compressible conductive layer, i.e. a layer that is compressible and comprises the electrically conductive species.

In some examples, the conductive layer comprises the electrically conductive species and a rubber, for example, an acrylic rubber (ACM), a nitrile rubber (NBR), a hydrogenated nitrile rubber (HNBR), or an EPDM rubber (an ethylene propylene diene terpolymer). In some examples, the rubber is an acrylic rubber (ACM). The electrically conductive species may be selected from carbon black, carbon nanotubes (e.g. single walled carbon nanotubes), an ionic material, metallic particles, metallic fibres or a combination thereof. In some examples, the compressible substrate layer and the conductive layer are the same layer.

In some examples, the conductive layer comprises the electrically conductive species in an amount of at least 2 wt. %, or at least 5 wt. %, or at least 10 wt. %, or at least 15.wt %, or at least 20 wt. %, or at least 30 wt. %, or at least 40 wt. % by weight of the conductive layer. The conductive layer comprises the electrically conductive species in an amount of from 2 wt. % to 50 wt %, optionally from 2 wt % to 40 wt. %.

In some examples, the layered structure may further comprise a compliant substrate layer on which the outer release layer may be disposed. In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM). In some examples, the compliant layer comprises an acrylic rubber (ABR). In some examples, the compliance layer comprises a thermoplastic polyurethane.

The compliance layer may comprise a soft elastomeric material having a Shore A hardness value of less than about 65, or a Shore A hardness value of less than about 55 and greater than about 35, or a Shore A hardness value of between about 42 and about 45. In some examples, the compliance layer 27 comprises a polyurethane, a thermoplastic polyurethane or an acrylic. Shore A hardness is determined by ASTM standard D2240.

In an example the compressible layer and the compliance layer are formed from the same material. In some examples, the compressible layer and/or the compliance layer may be made to be partially conducting with the addition of the electrically conductive species, for example, conductive carbon black, metal particles or metal fibres.

In some examples, the ITM may further comprise a base, for example a metal base. The base may have a cylindrical shape. The substrate layer may be disposed on the base of the ITM. In some examples, the compressible part or layer is disposed on the base of the ITM. In some examples, the compressible part or layer may be joined to the base of the ITM by an adhesive layer. The adhesive layer may be a fabric layer, for example a woven or non-woven cotton, synthetic, combined natural and synthetic, or treated, for example, treated to have improved heat resistance, material.

Primer Layer

In some examples, the embossed ITM may further comprise a primer layer disposed between the substrate layer and the outer release layer. This may facilitate bonding or joining of the release layer to the substrate layer. If the release layer comprises a cured silicone, the embossed ITM may comprise a primer layer to adhere the outer release layer to the substrate layer.

In some examples, the primer layer may comprise an organosilane, for example, an organosilane derived from a reactive silane group, or an organosilane derived from an epoxysilane such as 3-glycidoxypropyl trimethylsilane, a vinyl silane such as vinyltriethoxysilane, a vinyltriethoxysilane, an allyl silane, or an unsaturated silane, and a catalyst such as a catalyst comprising titanium or platinum. In some examples, the organosilane derives from an epoxysilane. In some examples, the organosilane derives from an epoxysilane and a vinyl silane.

In some examples, the primer layer may be formed from a curable primer composition. The curable primer composition may be applied to the substrate layer of the ITM, before the outer release layer is disposed on the substrate layer. The outer release layer may then be applied to the curable primer composition.

In some examples, curable primer composition may comprise a reactive organosilane and a catalyst. In some examples, the curable primer composition may comprise an organosilane selected from an epoxysilane, a vinyl silane, an allyl silane, an unsaturated silane or a combination thereof. The catalyst may be a catalyst for catalysing an addition reaction or a condensation reaction. The addition catalyst may comprise a platinum (0) catalyst, for example, platinum(0)-1,3-divinyl-1,1,3,3-tetramethyldisiloxane or platinum(0)-2,4,6,8-tetramethyl-2,4,6,8-tetravinylcyclotetrasiloxane. The condensation catalyst may comprise a titanium catalyst, for example, titanium acetylacetonate. Suitable titanium catalysts include Tyzor® AA-75.

In some examples, the curable primer composition comprises a first curable primer composition and a second curable primer composition. The first curable primer composition may be applied to the substrate layer of the ITM, and the second curable primer composition may be applied on to the first curable primer composition. The curable release formulation may then be applied to the second curable primer composition.

In some examples, the first curable primer composition may comprise an epoxysilane and a catalyst. In some examples, the epoxysilane is (3-Glycidyloxypropyl)trimethoxysilane. In some examples, the catalyst is a condensation catalyst. In some examples, the catalyst is a titanium catalyst, for example, titanium acetylacetonate.

In some examples, the first curable composition may comprise from 50 wt. % to 95 wt. % epoxysilane, in some examples, from 60 wt. % to 92 wt. % epoxysilane, in some examples, from 75 wt. % to 90 wt. % epoxysilane.

In some examples, the second curable primer composition may comprise a vinylsilane, an epoxysilane and a catalyst. In some examples, the vinylsilane is selected from vinyltrimethoxysilane and vinyltriethoxysilane. In some examples, the vinylsilane is vinyltrimethoxysilane. In some examples, the epoxysilane is (3-glycidyloxypropyl)trimethoxysilane. In some examples, the catalyst is an addition catalyst. In some examples, the catalyst is a platinum (0) catalyst. The platinum (0) catalyst may be a vinylsiloxane platinum (0) catalyst, for example, platinum (0)-1,3-divinyl-1,1,3,3-tetramethyldisiloxane or platinum(0)-2,4,6,8-tetramethyl-2,4,6,8-tetravinylcyclotetrasiloxane. In some examples, the first curable composition may comprise from 40 wt. % to 80 wt. % epoxysilane, in some examples, from 45 wt. % to 75 wt. % epoxysilane, in some examples, from 50 wt. % to 70 wt. % epoxysilane. In some examples, the first curable composition comprises from 15 wt. % to 55 wt. % vinylsilane, in some examples, from 25 wt. % to 45 wt. % vinylsilane, in some examples, from 30 wt. % to 40 wt. % vinylsilane.

In some examples, the embossed ITM comprises, in the following order:
a. a base (e.g. a metal base)
b. a fabric layer;
c. a compressible layer, which may have voids therein;
d. a conductive layer comprising electrically conductive species;
e. a compliant layer,
f. a primer layer, which may be formed from two curable primer compositions; and
g. an outer release layer, which may be formed by curing a curable release formulation, wherein the outer release layer comprises a structured surface.

In some examples, layers c and d may form part of the same layer. In some examples, layers d and e may form part of the same layer.

Method of Forming an Embossed ITM

In some examples, there is provided a method of forming an embossed intermediate transfer member for use in electrostatic printing, the method comprising:

providing (i) a substrate layer, at least part of which is compressible and comprises an electrically conductive species and (ii) a layer of curable release formulation disposed on the substrate layer;

contacting a the curable release formulation with the surface of a master material, the surface having 3-dimensional structures thereon;

curing the release formulation to form an outer release layer comprising a structured surface disposed on the substrate layer; and

removing the master material. The method of forming an embossed intermediate transfer member may be used to produce the embossed intermediate transfer members described herein.

Providing i) a Substrate Layer and ii) a Layer of Curable Release Formulation Disposed on the Substrate Layer

The substrate layer may be any substrate layer described herein and the curable release formulation may be any curable release formulation described herein.

In some examples, the method may further comprise applying the curable release formulation on the substrate layer. The curable release formulation may be applied onto the substrate layer by any suitable method, for example, extrusion, calendering, lamination, gravure coating, rod coating, flexo coating, screen coating, spray coating, roll coating, reverse roll coating, gap coating, slot die coating, immersion coating, curtain coating, air knife coating, flood coating, lithography, or combinations thereof. Using these methods, the curable release formulation can be processed in a straightforward manner with or without the use of solvents.

In some examples, the curable release formulation is applied onto the substrate layer by gravure coating. In some examples, the curable release formulation is applied onto the substrate layer at a gravure volume of 5 cm²/m³ or more, in some examples, 10 cm²/m³ or more, in some examples, 11 cm²/m³ or more, in some examples, 12 cm²/m³ or more, in some examples, 13 cm²/m³ or more, in some examples, 14 cm²/m³ or more, in some examples, 15 cm²/m³ or more, in some examples, 20 cm²/m³ or more. In some examples, the curable release formulation is applied onto the substrate layer at a gravure volume of 20 cm²/m³ or less, in some examples, 15 cm²/m³ or less, in some examples, 14 cm²/m³ or less, in some examples, 13 cm²/m³ or less, in some examples, 12 cm²/m³ or less, in some examples, 11 cm²/m³ or less, in some examples, 10 cm²/m³ or less, in some examples, 5 cm²/m³ or less. In some examples, the curable release formulation is applied onto the substrate layer at a gravure volume of 5 cm²/m³ to 20 cm²/m³, in some examples, 10 cm²/m³ to 15 cm²/m³, in some examples, 11 cm²/m³ to 14 cm²/m³, in some examples, 12 cm²/m³ to 14 cm²/m³, in some examples, 13 cm²/m³ to 14 cm²/m³

In some examples, the method further comprises mixing the components of the curable release formulation prior to applying the curable release formulation on the substrate layer. In some examples, the components may comprise mixing at least two of a polyalkylsiloxane comprising at least two vinyl groups, a polyalkylsiloxane crosslinker, a UV-A photoinitiator, a transition metal hydrosilylation catalyst, a thermal inhibitor, or conductive particles.

In some examples, the components of the curable release formulation are mixed by high shear mixing. In some examples, the high shear mixing is at 3,000 rpm or more, in some examples, 3,500 rpm or more, in some examples, 4,000 rpm or more, in some examples, 4,500 rpm or more, in some examples, 5,000 rpm or more, in some examples, 5,500 rpm or more, in some examples, 6,000 rpm or more, in some examples, 6,500 rpm or more, in some examples, 7,000 rpm or more, in some examples 7,500 rpm or more, in some examples, 8,000 rpm or more, in some examples, 8,500 rpm or more, in some examples, about 9,000 rpm. In some examples, the high shear mixing is at 9,000 rpm or less, in some examples, 8,500 rpm or less, in some examples, 8,000 rpm or less, in some examples, 7,500 rpm or less, in some examples, 7,000 rpm or less, in some examples, 6,500 rpm or less, in some examples, 6,000 rpm or less, in some examples, 5,500 rpm or less, in some examples, 5,000 rpm or less, in some examples, 4,500 rpm or less, in some examples, 4,000 rpm or less, in some examples, 3,500 rpm or less, in some examples, about 3,000 rpm. In some examples, the high shear mixing is at 3,000 rpm to 9,000 rpm, in some examples, 3,500 rpm to 8,500 rpm, in some examples, 4,000 rpm to 8,000 rpm, in some examples, 4,500 rpm to 7,500 rpm, in some examples, 5,000 rpm to 7,000 rpm, in some examples, 5,500 rpm to 6,500 rpm, in some examples, 6,000 rpm to 6,500 rpm, in some examples, 1,500 to 6,000, in some examples, 2,000 to 4,000.

In some examples, the method further comprises providing a layer of curable primer composition. The curable primer composition may be any curable primer composition described herein. The curable primer composition may comprise, for example, a first curable primer composition and a second curable primer composition, as described herein. In some examples, the method first comprises applying the curable primer composition on the substrate layer, before applying the curable release formulation on the curable primer composition.

In some examples, the curable primer composition is applied using gravure coating, calendering, rod coating, flexo coating, screen coating, spray coating, roll coating, reverse roll coating, gap coating, slot die coating, immersion coating, curtain coating, air knife coating, flood coating, lithography, or combinations thereof.

In some examples, the curable primer composition is applied onto the substrate layer by gravure coating. In some examples, both the first curable primer composition and the second primer composition are applied onto the substrate layer by gravure coating.

In some examples, the first curable primer composition is applied onto the substrate layer at a gravure volume of 0.5 cm²/m³ or more, in some examples, 1 cm²/m³ or more, in some examples, 1.5 cm²/m³ or more. In some examples, the first curable primer composition is applied onto the substrate layer at a gravure volume of 10 cm²/m³ or less, in some examples, 5 cm²/m³ or less, in some examples, 4 cm²/m³ or less, in some examples, 3 cm²/m³ or less. In some examples, the first curable primer composition is applied onto the substrate layer at a gravure volume of 0.5 cm²/m³ to 10 cm²/m³, in some examples, 1 cm²/m³ to 3 cm²/m³, in some examples, 1.5 cm²/m³ to 2.5 cm²/m³.

In some examples, the second curable primer composition is applied onto the substrate layer at a gravure volume of 5 cm²/m³ or more, in some examples, 10 cm²/m³ or more. In some examples, the second curable primer composition is applied onto the substrate layer at a gravure volume of 20 cm²/m³ or less, in some examples, 15 cm²/m³ or less, in some examples, 14 cm²/m³ or less, in some examples, 13 cm²/m³ or less, in some examples, 12 cm²/m³ or less, in some examples, 11 cm²/m³ or less, in some examples. In some examples, the second curable primer composition is applied onto the substrate layer at a gravure volume of 5 cm²/m³ to 20 cm²/m³, in some examples, 8 cm²/m³ to 15 cm²/m³, in some examples, 9 cm²/m³ to 12 cm²/m³, in some examples, 10 cm²/m³ to 11 cm²/m³.

Contacting the Curable Release Formulation with the Surface of a Master Material, the Master Material Having 3 Dimensional Structures Thereon

The curable release formulation may be contacted with the surface of the master material by any suitable method. In some examples, the master material is laid on the curable release formulation, and the combination is then subjected to a condition that cure the curable release formulation (e.g. by UV radiation and/or heat), and the master material is removed.

In some examples, the master material is contacted with a portion of the curable release formulation. In some examples, the master material is contacted with at least 1% by area of the curable release formulation, or at least 5%, or at least 10%, or at least 20%, or at least 30%, or at least 40%, or at least 50%, or at least 60%, or at least 70%, or at least 80%, or at least 90%, or with 100% by area of the curable release formulation.

In some examples, the 3 Dimensional structures are nanostructures. In some examples, the nanostructures are holographic. The nanostructures may have any suitable dimensions for forming an embossed ITM as described herein. The nanostructures may have a height from 0.1 to 100 nm, or from 1 nm to 75 nm, or from 3 nm to 60 nm, or from 5 nm to 50 nm, or from 10 nm to 40 nm. The nanostructures may have a height of less than 100 nm, or less than 80 nm, or less than 70 nm, or less than 60 nm. The nanostructures may be on a surface with a mean surface roughness (Rₐ) from 0.1 to 100 nm, or from 1 nm to 75 nm, or from 3 nm to 60 nm, or from 5 nm to 50 nm, or from 10 nm to 40 nm. In some examples, the nanostructures may be on a surface with a mean surface roughness (Rₐ) of less than 100 nm, or less than 90 nm, or less than 80 nm, or less than 70 nm, or less than 60 nm, or less than 50 nm, or less than 40 nm. In some examples, the nanostructures may be on a surface with a root mean square surface roughness (R_{q}) from 0.1 nm to 100 nm, or from 1 nm to 75 nm, or from 3 nm to 60 nm, or from 5 nm to 50 nm, or from 10 nm to 40 nm. In some examples, the nanostructures may be on a surface with a root mean square surface roughness (R_{q}) of less than 100 nm, or less than 90 nm, or less than 80 nm, or less than 70 nm, or less than 60 nm, or less than 50 nm, or less than 40 nm. The nanostructures may be arranged in any suitable pattern. The pattern may be a regular or an irregular pattern. The pattern may be selected from dots, repeating geometric shapes, spirals, prints, stripes, an image, numbers, letters, symbols or any other pattern suitable for forming a hologram.

In some examples, the 3-Dimensional structures are microstructures. The microstructures surface can be used to form a microstructured surface on the embossed ITM. The microstructures may have a height from 0.25 μm to 100 μm, or from 0.3 μm to 50 μm, or from 0.4 μm to 10 μm, or from 0.5 μm to 5 μm. The microstructures may have a height from 0.25 μm to 100 μm, or from 0.3 μm to 50 μm, or from 0.4 μm to 10 μm, or from 0.5 μm to 5 μm. The microstructures may be on a surface with a mean surface roughness (Rₐ) from 0.25 μm to 100 μm, or from 0.3 μm to 50 μm, or from 0.4 μm to 10 μm, or from 0.5 μm to 5 μm. The microstructures may be on a surface with a root mean square surface (R_{q}) roughness of from 0.25 μm to 100 μm, or from 0.3 μm to 50 μm, or from 0.4 μm to 10 μm, or from 0.5 μm to 5 μm. The microstructures may be arranged in any suitable pattern. The microstructured surface may have a regular or an irregular pattern. The microstructures may have any suitable pattern. The microstructures may be in the form of a pattern selected from dots, repeating geometric shapes, spirals, prints, stripes, an image, numbers, letters, symbols or any other pattern suitable for forming a watermark.

The master material may be made of any suitable material. In some examples, the master material is made of any suitable material that can withstand a temperature of at least 50° C., or at least 60° C., or at least 70° C., or at least 80° C., or at least 90° C., or at least 100° C., or at least 110° C., or at least 120° C. In some examples, the master material is made of any suitable material that does not adhere to the outer release layer after curing. In some examples, the master material comprises a plastic, for example, a plastic film. In some examples, the master material comprises a polyalkylene, a polyester or a polyamide, for example, a biaxially orientated polyalkylene, a biaxially oriented polyester or a biaxially orientated polyamide. In some examples, the master material comprises a polyethylene or polypropylene. In some examples, the polypropylene is a biaxially orientated polypropylene (BOPP).

The master material may have any suitable thickness. In some examples, the master material has a thickness from 0.01 mm to 100 mm, or from 0.01 mm to 10 mm, or from 0.01 mm to 2 mm, or from 0.01 mm to 0.05 mm. In some examples, the master material has a thickness that is greater than 0.1 mm, or greater than 0.25 mm, or greater than 0.5 mm, or greater than 0.75 mm, or greater than 1 mm. In some examples, the master material has a thickness that is less than 100 mm, or less than 50 mm, or less than 25 mm, or less than 5 mm, or less than 1 mm.

Curing

In some examples, the curable release formulation is cured thermally or cured by radiation with UV light, for example, UV-A light. Curing the release formulation in contact with the surface of the master material, forms an outer release layer comprising a structured surface disposed on the substrate layer. The outer release layer comprising a structured surface may be any of the outer release layers described herein.

In some examples, the curable release formulation is a thermal curable release formulation that is cured thermally. In some examples, the thermal curable release formulation is cured by heating the thermal curable release formulation to a temperature of about 40° C. or greater, or about 50° C. or greater, or about 60° C. or greater, or about 70° C. or greater, or about 80° C. or greater, or about 100° C. or greater, or about 110° C. or greater, or by heating to a temperature of about 120° C. or greater. In some examples, the heating occurs in an oven. In some examples, the thermal curable release formulation is cured by heating the thermal curable release formulation for at least 30 minutes, or for at least 1 hour, or for at least 2 hours, or for at least 3 hours, or for at least 4 hours. In an example, the thermal curable release formulation is cured by heating the thermal curable release formulation to a temperature of 120° C. for 4 hours.

In some examples, the curable release formulation is a UV curable release formulation that is cured with UV light, for example, UV-A light. In some examples, the curable release formulation is cured with UV light with a wavelength of from 200 nm to 400 nm, in some examples, from 350 nm to 400 nm, in some examples, from 380 nm to 400 nm, in some examples, from 390 nm to 400 nm.

In some examples, the method comprises curing the UV curable release formulation by irradiating the UV curable release formulation for 1 second or more, in some examples, 2 seconds or more, in some examples, 3 seconds or more, in some examples, 4 seconds or more, in some examples, 5 seconds or more, in some examples, 6 seconds or more, in some examples, 7 seconds or more, in some examples, 8 seconds or more, in some examples, 9 seconds or more, in some examples, 10 seconds or more, in some examples, 15 seconds or more, in some examples, 20 seconds or more. In some examples, the method comprises curing the UV curable release formulation by irradiating the curable release formulation for 20 seconds or less, in some examples, 10 seconds or less, in some examples, 9 seconds or less, in some examples 8 seconds or less, in some examples, 7 seconds or less, in some examples, 6 seconds or less, in some examples, 5 seconds or less, in some examples, 5 seconds or less, in some examples, 4 seconds or less, in some examples, 3 seconds or less, in some examples, 2 seconds or less, in some examples, 1 second or less. In some examples, the method comprises curing the UV curable release formulation by irradiating the curable release formulation for 1 second to 20 seconds, in some examples, 2 seconds to 10 seconds, in some examples, 3 seconds to 9 seconds, in some examples, 4 seconds to 8 seconds, in some examples, 5 seconds to 7 seconds, in some examples, 5 seconds to 6 seconds.

In some examples, the UV curable release formulation passes the UV irradiation source, for example, at a speed of 1 m/min or more, in some examples, 2 m/min or more, in some examples, 3 m/min or more, in some examples, 4 m/min or more, in some examples, 5 m/min or more, in some examples, 6 m/min or more, in some examples, 7 m/min or more, in some examples, 8 m/min or more, in some examples, 9 m/min or more, in some examples, 10 m/min or more. In some examples, the UV curable release formulation passes the UV irradiation source at a speed of 10 m/min or less, in some examples, 9 m/min or less, in some examples, 8 m/min or less, in some examples, 7 m/min or less, in some examples, 6 m/min or less, in some examples, 5 m/min or less, in some examples, 4 m/min or less, in some examples, 3 m/min or less, in some examples, 2 m/min or less, in some examples, 1 m/min or less. In some examples, the UV curable release formulation passes the UV irradiation source at a speed of 1 m/min to 10 m/min, in some examples, 2 m/min to 9 m/min, in some examples, 2 m/min to 8 m/min, in some examples, 3 m/min to 7 m/min, in some examples, 4 m/min to 6 m/min, in some examples, 5 m/min to 6 m/min.

In some examples, the UV irradiation source is an LED UV lamp. In some examples, the UV irradiation source is any source that emits UV-A irradiation. It is also possible to use other sources that emit UV-A irradiation, for example in combination with shorter wavelength UV radiation such as UV-B and UV-C radiation, such as a mercury UV lamp.

In some examples, after irradiating with UV irradiation, the intermediate transfer member is left at room temperature to ensure full curing of the curable release formulation prior to use in a electrostatic printing apparatus. In some examples, after irradiating with UV irradiation, the intermediate transfer member is left at room temperature for 24 hours under ambient light to ensure full curing of the UV curable release formulation prior to use in a electrostatic printing apparatus.

In some examples, curing the UV curable release formulation comprises irradiating the curable release formulation with UV light and then heating the UV curable release formulation. In some examples, after irradiating with UV irradiation, the intermediate transfer member is heated to ensure full curing of the UV curable release formulation. In some examples, heating of the ITM involves heating at greater than room temperature, for example heating at a temperature of about 40° C. or greater, about 50° C. or greater, about 60° C. or greater, about 80° C. or greater, about 100° C. or greater, for example 120° C. In some examples, heating of the ITM involves heating at a temperature greater than room temperature to about 200° C., for example from about 40° C. to about 150° C. In some examples, the ITM is heated for at least 1 hour, for example about 2 hours, or at least 4 hours.

In some examples, the curing treatment can be used to simultaneously cure the curable primer composition and the curable release formulation.

Removing the Master Material

The master material may be removed by any suitable method, for example, by peeling. In some examples, the master material can be removed without distorting the structured surface of the outer release layer. In some examples, wherein the outer release layer is a cured silicone release layer, the master material does not stick within the cured silicone release layer after curing, facilitating its easy removal.

Electrostatic Printing Method

In some examples, there is provided an electrostatic printing method for forming a structured image on a print substrate, the method comprising:

providing an electrostatic ink composition;

contacting the electrostatic ink composition with a latent electrostatic image on a photoconductive surface to create a developed toner image;

transferring the developed toner image to an embossed intermediate transfer member to create a structured toner image; and;

transferring the structured toner image to a print substrate.

Providing an Electrostatic Ink Composition

In some examples, the electrostatic ink composition may be a liquid electrostatic ink composition. In some examples, the electrostatic ink comprises chargeable particles dispersed in a carrier fluid. In some examples, the electrostatic ink may comprise a carrier fluid, a resin, a colorant and a charge director and/or a charge adjuvant. In some examples, the electrostatic ink composition may further comprise other additives or a plurality of other additives.

Carrier Fluid

The electrostatic ink composition comprises, before printing, a carrier fluid.

In some examples, when printing, the electrostatic ink composition comprises a carrier fluid. Generally, the carrier fluid can act as a dispersing medium for the other components in the electrostatic composition. For example, the carrier fluid can comprise or be a hydrocarbon, silicone oil, vegetable oil, and so forth. The carrier fluid can include, but is not limited to, an insulating, non-polar, non-aqueous liquid that can be used as a medium for toner particles. The carrier fluid can include compounds that have a resistivity in excess of about 10⁹ ohm-cm. The carrier fluid may have a dielectric constant below about 5, in some examples below about 3. The carrier fluid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier fluid include, but are not limited to, aliphatic hydrocarbons, isoparaffinic compounds, paraffinic compounds, dearomatized hydrocarbon compounds, and the like. In some examples, the hydrocarbon may be one or more isoparaffins having 5 to 15 carbon atoms, for example, 10 to 14 carbon atoms, 11 to 13 carbon atoms. In particular, the carrier fluid can include, but are not limited to, Isopar-G™, Isopar-H™, Isopar-L™, Isopar-M™, Isopar-K™, Isopar-V™, Norpar 12™, Norpar 13™ Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™ Nisseki Naphthesol L™, Nisseki Naphthesol M™, Nisseki Naphthesol H™, #0 Solvent L™ #0 Solvent M™, #0 Solvent H™, Nisseki Isosol 300™, Nisseki Isosol 400™, AF-4™, AF-5™ AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™) Before electrostatic printing, the carrier fluid can constitute about 20% to 99.5% by weight of the liquid electrostatic ink composition, in some examples 50% to 99.5% by weight of the liquid electrostatic ink composition. Before printing, the carrier fluid may constitute about 40% to 90% by weight of the electrostatic ink composition. Before printing, the liquid carrier may constitute about 60% to 80% by weight of the liquid electrostatic ink composition. Before printing, the liquid carrier may constitute about 90% to 99.5% by weight of the liquid electrostatic ink composition, in some examples 95% to 99% by weight of the liquid electrostatic ink composition.

The liquid electrostatic ink composition, once electrostatically printed on the substrate, may be substantially free from liquid carrier. In an electrostatic printing process and/or afterwards, the liquid carrier may be removed, for example, by an electrophoresis processes during printing and/or evaporation, such that substantially just solids are transferred to the substrate. Substantially free from liquid carrier may indicate that liquid electrostatically printed ink contains less than 5 wt. % liquid carrier, in some examples, less than 2 wt. % liquid carrier, in some examples less than 1 wt. % liquid carrier, in some examples less than 0.5 wt. % liquid carrier. In some examples, liquid electrostatically printed ink is free from liquid carrier.

Resin

The electrostatic ink composition may comprise a resin, which may be a thermoplastic resin. In some examples, the thermoplastic resin may comprise a polymer selected from ethylene acrylic acid copolymers; ethylene methacrylic acid copolymers; ethylene vinyl acetate copolymers; copolymers of ethylene (e.g. 80 wt. % to 99.9 wt. %), and alkyl (e.g. C1 to C5) ester of methacrylic or acrylic acid (e.g. 0.1 wt. % to 20 wt. %); copolymers of ethylene (e.g. 80 wt. % to 99.9 wt. %), acrylic or methacrylic acid (e.g. 0.1 wt. % to 20 wt. %) and alkyl (e.g. C1 to C5) ester of methacrylic or acrylic acid (e.g. 0.1 wt. % to 20 wt. %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt. % to 90 wt. %)/methacrylic acid (e.g. 0 wt. % to 20 wt. %)/ethylhexylacrylate (e.g. 10 wt. % to 50 wt. %)); ethylene-acrylate terpolymers: ethylene-acrylic esters-maleic anhydride (MAH) or glycidyl methacrylate (GMA) terpolymers; ethylene-acrylic acid ionomers and combinations thereof.

The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g, can be measured using standard procedures known in the art, for example, using the procedure described in ASTM D1386.

The thermoplastic resin may comprise a polymer having acidic side groups that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example, as described in ASTM D1238.

The thermoplastic resin may comprise a copolymer of an alkylene monomer and a monomer having acidic side groups. In some examples, the alkylene monomer may be selected from ethylene and propylene. In some examples, the monomer having acidic side groups may be selected from methacrylic acid and acrylic acid. In some examples, the thermoplastic resin may comprise a copolymer of an alkylene monomer and a monomer selected from methacrylic acid and acrylic acid. In some examples, the thermoplastic resin may comprise a copolymer of ethylene and a monomer selected from methacrylic acid and acrylic acid.

In some examples, the polymer having acidic side groups is a copolymer of an alkylene monomer and a monomer selected from acrylic acid and methacrylic acid. In some examples, the thermoplastic resin may comprise a copolymer of an alkylene monomer and a monomer selected from acrylic acid and methacrylic acid.

The acidic side groups may be in free acid form or may be in the form of an anion and associated with one or more counterions, for example, metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt. % to about 25 wt. % of the copolymer, in some examples from 10 wt. % to about 20 wt. % of the copolymer.

The thermoplastic resin may comprise two different polymers having acidic side groups. The two polymers having acidic side groups may have different acidities, which may fall within the ranges mentioned above. The thermoplastic resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise a copolymer of ethylene and acrylic acid and a copolymer of ethylene and methacrylic acid.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less.

The resin may comprise two different polymers having acidic side groups: a first polymer that is a copolymer of ethylene (e.g. 92 to 85 wt. %, in some examples about 89 wt. %) and acrylic or methacrylic acid (e.g. 8 to 15 wt. %, in some examples about 11 wt. %) having a melt flow rate of 80 to 110 g/10 minutes and a second polymer that is a copolymer of ethylene (e.g. about 80 to 92 wt. %, in some examples about 85 wt. %) and acrylic acid (e.g. about 18 to 12 wt. %, in some examples about 15 wt. %), having a melt viscosity lower than that of the first polymer, the first polymer having a melt viscosity of 10000 poise or more, or 15000 poise or more, or from 15000 poise to 40000 poise, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. An example of the first polymer s Nucrel 699 (from DuPont), and an example of the second polymer is AC-5120 (from Honeywell).

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

In an example, the resin constitutes about 5 to 90%, in some examples about 5 to 80% by weight of the total solids of the electrostatic ink composition. In another example, the resin constitutes about 10 to 60% by weight of the total solids of the electrostatic ink composition. In another example, the resin constitutes about 15 to 40% by weight of the total solids of the electrostatic ink composition. In another example, the resin constitutes about 60 to 95% by weight, in some examples, from 65 to 90% by weight, from 65 to 80% by weight of the total solids of the electrostatic ink composition. In an example, the resin constitutes 80% by weight of the total solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a copolymer of a monomer having ester side groups and a monomer having acidic side groups. The polymer may be a copolymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, tert-butyl, iso-butyl, n-butyl and pentyl.

The polymer having ester side groups may be a copolymer of a first monomer having ester side groups, a second monomer having acidic side groups and a third monomer which is an alkylene monomer absent of any acidic and ester side groups. The polymer having ester side groups may be a copolymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the copolymer, in some examples 5 to 40% by weight, in some examples 5 to 20% by weight of the copolymer, in some examples 5 to 15% by weight of the copolymer. The second monomer may constitute 1 to 50% by weight of the copolymer, in some examples 5 to 40% by weight of the copolymer, in some examples 5 to 20% by weight of the copolymer, in some examples 5 to 15% by weight of the copolymer. In an example, the first monomer constitutes 5 to 40% by weight of the copolymer, the second monomer constitutes 5 to 40% by weight of the copolymer, and with the third monomer constituting the remaining weight of the copolymer. In an example, the first monomer constitutes 5 to 15% by weight of the copolymer, the second monomer constitutes 5 to 15% by weight of the copolymer, with the third monomer constituting the remaining weight of the copolymer. In an example, the first monomer constitutes 8 to 12% by weight of the copolymer, the second monomer constitutes 8 to 12% by weight of the copolymer, with the third monomer constituting the remaining weight of the copolymer. In an example, the first monomer constitutes about 10% by weight of the copolymer, the second monomer constitutes about 10% by weight of the copolymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™ Bynell 2002, Bynell 2014, and Bynell 2020 (sold by E. I. du PONT)), the Aclyn family of toners (e.g. Aclyn 201, Aclyn 246, Aclyn 285, and Aclyn 295), AC-5120 and AC 580 (sold by Honeywell), and the Lotader family of toners (e.g. Lotader 2210, Lotader, 3430, and Lotader 8200 (sold by Arkema)).

Colorant

The electrostatic ink composition may include a colorant. In some examples, the colorant may be a dye or pigment.

As used herein, “colorant” may be a material that imparts a colour to the ink composition. As used herein, “colorant” includes pigments and dyes, such as those that impart colours, such as black, magenta, cyan, yellow and white, to an ink. As used herein, “pigment” generally includes pigment colorants, magnetic particles, aluminas, silicas, and/or other ceramics or organometallics. Thus, though the present description primarily exemplifies the use of pigment colorants, the term “pigment” can be used more generally to describe not only pigment colorants, but also other pigments such as organometallics, ferrites, ceramics, and so forth.

In some examples, the colorant is selected from cyan colorants, magenta colorants, yellow colorants, black colorants, white colorants and silver colorants. In some examples, the colorant is selected from cyan pigments, magenta pigments, yellow pigments, black pigments, white pigments and silver pigments. In some examples, the colorant may be a black pigment or cyan pigment. In some examples, the colorant may be a black pigment. In some examples, it was found that dark pigments, such as black or cyan pigments, led to a more visually appealing structured image.

The colorant can be any colorant compatible with the carrier liquid and useful for electrostatic printing. For example, the colorant may be present as pigment particles, or may comprise a resin as described herein and a pigment. The pigments can be any of those standardly used in the art. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW 5GT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. If the pigment is a white pigment particle, the pigment particle may be selected from the group consisting of TiO₂, calcium carbonate, zinc oxide, and mixtures thereof. In some examples, the white pigment particle may comprise an alumina-TiO₂ pigment. If the pigment is a silver pigment, the pigment may be an aluminium powder.

Charge Director and Charge Adjuvant

In some examples, the electrostatic ink composition includes either a charge director or a charge adjuvant or both.

The charge director may be added in order to impart and/or maintain sufficient electrostatic charge on ink particles during electrostatic printing, which may be particles comprising the thermoplastic resin. The charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of an electrostatic ink composition.

In some examples, the electrostatic ink composition comprises a charge director comprising a simple salt. Simple salts are salts that do not form micelles by themselves, although they may form a core for micelles with a micelle forming salt. The ions constructing the simple salts are all hydrophilic. The simple salt may include a cation selected from the group consisting of Mg, Ca, Ba, NH4, tert-butyl ammonium, Li+, and Al+3, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F—, ClO₄—, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)3, LiClO₄ and LiBF₄, or any sub-group thereof.

The charge director may include at least one of (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In some examples, the electrostatic ink composition comprises a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²]⁻ wherein each of R¹ and R² is an alkyl group. (I)

The sulfosuccinate salt of the general formula MAn is an example of a micelle forming salt. The charge director may be substantially free or free of an acid of the general formula HA, where A is as described above. The charge director may include micelles of said sulfosuccinate salt enclosing at least some of the nanoparticles. The charge director may include at least some nanoparticles having a size of 200 nm or less, and/or in some examples 2 nm or more.

In the formula [R₁—O—C(O)CH₂CH(SO₃⁻)C(O)—O—R₂], in some examples each of R₁ and R₂ is an aliphatic alkyl group. In some examples, each of R₁ and R₂ independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇. In some examples, M is Na, K, Cs, Ca, or Ba.

In some examples, the charge director constitutes about 0.001% to 20%, in some examples 0.01% to 20% by weight, in some examples 0.01 to 10% by weight, in some examples 0.01% to 1% by weight of the solids of an electrostatic ink composition. In some examples, the charge director constitutes about 0.001% to 0.15% by weight of the solids of the electrostatic ink composition, in some examples 0.001% to 0.15%, in some examples 0.001% to 0.02% by weight of the solids of an electrostatic ink composition, in some examples 0.1% to 2% by weight of the solids of the electrostatic ink composition, in some examples 0.2% to 1.5% by weight of the solids of the electrostatic ink composition in some examples 0.1% to 1% by weight of the solids of the electrostatic ink composition, in some examples 0.2% to 0.8% by weight of the solids of the electrostatic ink composition. In some examples, the charge director is present in an amount of at least 1 mg of charge director per gram of solids of the electrostatic ink composition (which will be abbreviated to mg/g), in some examples at least 2 mg/g, in some examples at least 3 mg/g, in some examples at least 4 mg/g, in some examples at least 5 mg/g. In some examples, the charge director is present in the amounts stated above, and the charge director is present in an amount of from 1 mg to 50 mg of charge director per gram of solids of the electrostatic ink composition (which will be abbreviated to mg/g), in some examples from 1 mg/g to 25 mg/g, in some examples from 1 mg/g to 20 mg/g, in some examples from 1 mg/g to 15 mg/g, in some examples from 1 mg/g to 10 mg/g, in some examples from 3 mg/g to 20 mg/g, in some examples from 3 mg/g to 15 mg/g, in some examples from 5 mg/g to 10 mg/g.

A charge adjuvant may promote charging of the particles when a charge director is present in the electrostatic ink composition during printing. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmitate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminum di- or tristearate. The charge adjuvant may be present in an amount of about 0.1 to 5% by weight, in some examples about 0.1 to 1% by weight, in some examples about 0.3 to 0.8% by weight of the solids of the electrostatic ink composition, in some examples about 1 wt % to 3 wt % of the solids of the electrostatic ink composition, in some examples about 1.5 wt % to 2.5 wt % of the solids of the electrostatic ink composition.

In some examples, the electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al3+. The fatty acid anion may be selected from a saturated or unsaturated fatty acid anion. The fatty acid anion may be selected from a C₈ to C₂₆ fatty acid anion, in some examples a C₁₄ to C₂₂ fatty acid anion, in some examples a C₁₆ to C₂₀ fatty acid anion, in some examples a C₁₇, C₁₈ or C₁₉ fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of multivalent cation and a fatty acid anion, may be present in an amount of 0.1 wt % to 5 wt % of the solids of the electrostatic ink composition, in some examples in an amount of 0.1 wt % to 2 wt % of the solids of the electrostatic ink composition, in some examples in an amount of 0.1 wt % to 2 wt % of the solids of the electrostatic ink composition, in some examples in an amount of 0.3 wt % to 1.5 wt % of the solids of the electrostatic ink composition, in some examples about 0.5 wt % to 1.2 wt % of the solids of the electrostatic ink composition, in some examples about 0.8 wt % to 1 wt % of the solids of the electrostatic ink composition, in some examples about 1 wt % to 3 wt % of the solids of the electrostatic ink composition, in some examples about 1.5 wt % to 2.5 wt % of the solids of the electrostatic ink composition.

Contacting the Electrostatic Ink Composition with a Latent Electrostatic Image on a Photoconductive Surface

The photoconductive surface on which the latent electrostatic image is formed may be on a rotating member, e.g. in the form of a cylinder. The surface on which the latent electrostatic image is formed may form part of a photo imaging plate (PIP). The contacting may involve passing the electrostatic ink between a stationary electrode and a rotating member, which may be a member having the surface having a latent electrostatic image thereon or a member in contact with the surface having a latent electrostatic image thereon. A voltage is applied between the stationary electrode and the rotating member, such that the particles adhere to the surface of the rotating member. This may involve subjecting the electrostatic ink composition to an electric field having a field gradient of 50-400V/μm, or more, in some examples 600-900V/μm, or more.

Transferring the Developed Toner Image

The developed toner image may then be transferred to an embossed intermediate transfer member to create a structured toner image. In some examples, the structured toner image is a hologram or a watermark. In some examples, the developed toner image is transferred to the embossed intermediate transfer member at least once, before the structured toner image is transferred to the print substrate. In some examples, the develop toner image is transferred, at least two times, or at least three times, or at least four times, or at least five times, or at least six times, or at least seven times, or at least eight times, or at least nine times, or at least ten times, or at least twenty times, or at least fifty times before the structured toner image is transferred to the print substrate. In some examples, the structured toner image has a thickness of at least 0.5 μm, or at least 1 μm, or at least 2 μm, or at least 3 μm, or at least 4 μm, or at least 5 μm, or at least 6 μm, or at least 7 μm, or at least 8 μm, or at least 9 μm, or at least 10 μm. In some examples, the structured toner image has a thickness of from 0.5 μm to 50 μm, in some examples from 5 μm to 30 μm, in some examples from 10 μm to 30 μm, in some examples from 10 μm to 20 μm. It was found that structured toner images with a higher thickness (i.e. formed from sequential transfers of the developed toner image to the embossed ITM) resulted in a structured image with a more well-defined structure. In some examples, the structured toner images are printed with at least 100% coverage, or at least 200% coverage, or at least 300% coverage, or at least 400% coverage.

In some examples of the method, the embossed intermediate transfer member may be heated. In some examples, the embossed intermediate transfer member is heated to a temperature of from 50° C. to 200° C., in some examples from 80 to 160° C., in some examples from 90 to 130° C., in some examples from 100 to 110° C., in some examples, about 105° C.

Heating the ITM may be useful for melting the resin in the electrostatic ink composition and/or improve transferability of the structured toner image to the substrate. This may be useful for forming a well-defined structured toner image. Heating the ITM may also help to remove the carrier fluid.

Transferring the Structured Toner Image to a Print Substrate

The structured toner image may be transferred to a print substrate to form a structured image. In some examples, the structured image is a hologram or a watermark.

The print substrate may be any suitable medium capable of having an image printed thereon. The print substrate may include a material selected from an organic or inorganic material. The material may include a natural polymeric material, e.g. cellulose. The material may include a synthetic polymeric material, e.g. a polymer formed from alkylene monomers, including, but not limited to, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (AI), silver (Ag), tin (Sn), copper (Cu), mixtures thereof. The metal may be an elemental metal or a metal in alloy form. The material may comprise wood or glass and may be in sheet form. In an example, the print medium includes a cellulosic paper. In an example, the cellulosic paper is coated with a polymeric material, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The print substrate is, in some examples, a cellulosic print medium such as paper. The cellulosic print medium is, in some examples, a coated cellulosic print. In some examples, a primer may be coated onto the print medium, before the electrostatic ink composition is printed onto the print substrate.

In some examples, the print substrate comprises a film or sheet of at least one of paper, metallic foil, and plastic. In some examples, the print substrate is transparent. In some examples, the print substrate comprises a metallized paper or a metallized plastic film. In some examples, the print substrate comprises an aluminium foil. In some examples the print substrate comprises a film of a plastic material, for example, polyethylene (PE), linear low density polyethylene (LLDPE), low density polyethylene (LDPE), polypropylene (PP), biaxially oriented polypropylene (BOPP). In some examples, the print substrate comprises a metallized paper in the form of a paper substrate coated on one surface with a layer of metal, for example aluminium. In some examples, the print substrate comprises a metallized plastic film in the form of a polymer substrate coated on one surface with a layer of metal, for example aluminium. In some examples, the print substrate comprises a metallized plastic film in the form of a metallized BOPP film, a metallized PET film, or a metallized polyethylene (PE) film.

In some examples, the print substrate comprises a film of material, wherein the film is less than 100 μm in thickness, for example less than 90 μm in thickness, less than 80 μm in thickness, less than 70 μm in thickness, less than 60 μm in thickness, less than 50 μm in thickness, less than 40 μm in thickness, less than 30 μm in thickness, less than 20 μm in thickness, less than 15 μm in thickness. In some examples, the film of material is about 12 μm in thickness.

In some examples, the print substrate comprises a film of material, wherein the film is greater than 12 μm in thickness, for example greater than 15 μm in thickness, greater than 20 μm in thickness, greater than 30 μm in thickness, greater than 40 μm in thickness, greater than 50 μm in thickness, greater than 60 μm in thickness, greater than 70 μm in thickness, greater than 80 μm in thickness, greater than 90 μm in thickness. In some examples, the film of material is about 100 μm in thickness.

In some examples, the print substrate comprises a fabric, for example a woven fabric, a knitted fabric or a non-woven fabric. A fabric may be a cloth made from yarn or fibres by weaving, knitting, felting or other techniques. In some examples, the print substrate comprises a fabric formed from yarns comprising material selected from polyester, polyamides, polyvinyl alcohols, lyocell, rayon, viscose, nylon, cotton, linen, flax, hemp, jute and wool, acetates, acrylic, elastane, silk or any combination thereof.

In an example, the printed substrate is a primer coated paper (e.g. a commercially available paper is Condat with primer 050).

The electrostatic printing may be carried out so that a plurality of print substrate sheets are printed, for example 10 or more print substrate sheets, in some examples 100 or more print substrate sheets, in some examples 500 or more print substrate sheets, in some examples 1000 or more print substrate sheets. The sheets may be any suitable size or shape, e.g. of standard printing size, such as A4 or A3.

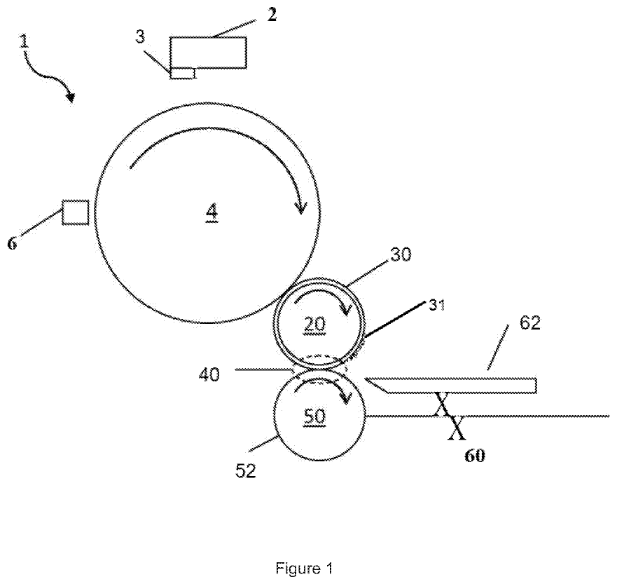

FIG. 1 shows a schematic illustration of an example of an electrostatic printing apparatus 1 and the use of an embossed intermediate transfer member therein. An image, including any combination of graphics, text and images, is communicated to the electrostatic printing apparatus 1. The electrostatic printing apparatus includes a photo charging unit 2 and a photo-imaging cylinder 4. The image is initially formed on a photoimaging plate (also known as a photoconductive member), in this case in the form of a photo-imaging cylinder 4, before being transferred to an embossed ITM 20 comprising a structured surface 31 (in this example, the embossed ITM comprising an outer release layer (30) comprising the structured surface (31)) which is in the form of a roller (first transfer), and then from the structured surface 31 of the embossed ITM 20 to a print substrate 62 (second transfer).

According to an illustrative example, the initial image is formed on a rotating photo-imaging cylinder 4 by the photo charging unit 2. Firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. Liquid electrostatic ink is then transferred to the photo-imaging cylinder 4 by binary ink developer (BID) units 6. The BID units 6 present a uniform film of liquid electrostatic ink to the photo-imaging cylinder 4. The liquid electrostatic ink contains electrically charged pigment particles which, by virtue of an appropriate potential on the electrostatic image areas, are attracted to the latent electrostatic image on the photo-imaging cylinder 4. The liquid electrostatic ink does not adhere to the uncharged, non-image areas and forms a developed toner image on the surface of the latent electrostatic image. The photo-imaging cylinder 4 then has a single colour ink image on its surface.

The developed toner image may be transferred from the photo-imaging cylinder 4 to the structured surface 31 of the embossed ITM 20 (in this example, the embossed ITM 20 comprising an outer release layer 30, the outer release layer comprising the structured surface 31) by electrical forces to form a structured toner image. The structured toner image may then be dried and fused on the structured surface 31 of the embossed ITM 20. The structured toner image is then transferred from the structured surface 31 (in this example, on the outer release layer 30) of the embossed ITM 20 to a print substrate disposed on impression cylinder 50. The process may then be repeated.

The developed toner image is transferred from the photo-imaging cylinder 4 to the embossed ITM 20 to form a structured toner image by virtue of an appropriate potential applied between the photo-imaging cylinder 4 and the embossed ITM 20, such that the charged ink is attracted to the embossed ITM 20.

The print substrate 62 is fed into the printing apparatus by the print substrate feed tray 60 and is disposed on the impression cylinder 50. As the print substrate 62 contacts the structured surface 31 of the embossed ITM 20, the structured image is transferred to the print substrate 62.

### EXAMPLES

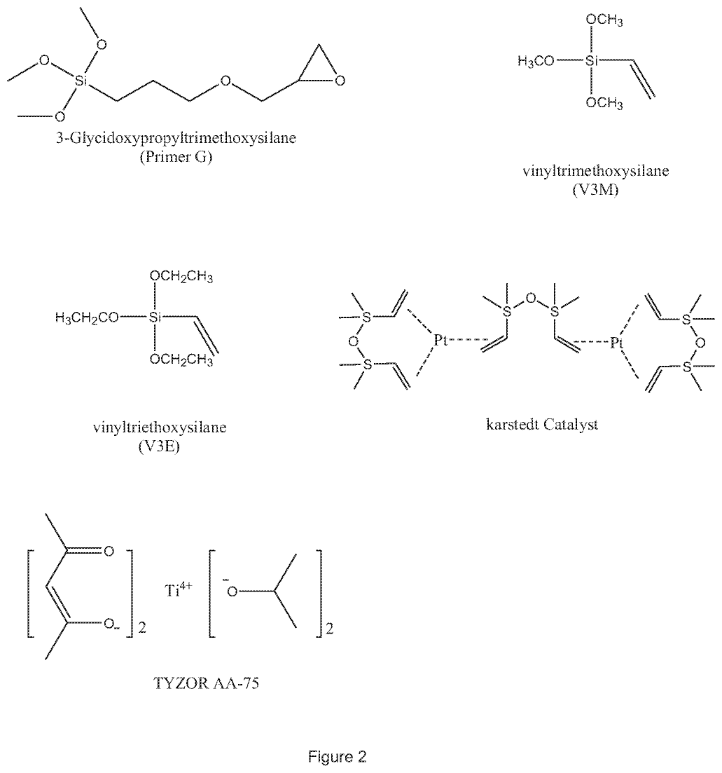

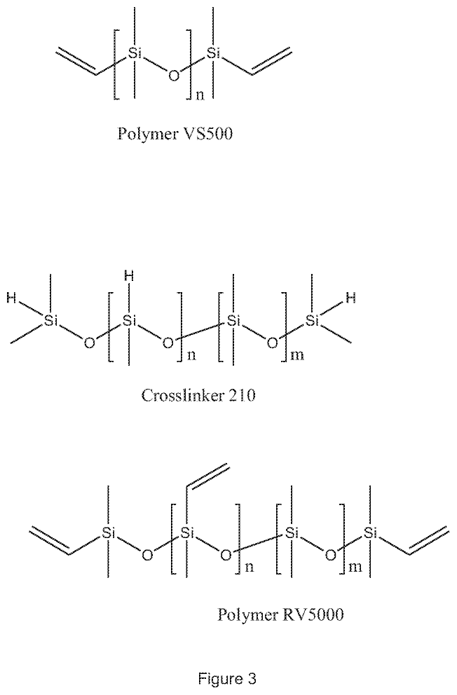

Materials: 3-Glycidoxypropyltrimethoxysilane (primer G); vinyltrimethoxysilane (V3M); Tyzor AA-75 (TYZ); and vinyltriethoxysilane (V3E) were obtained from ABCR GmbH (Im Schlehert 10, 76187 Karlsruhe, Germany) and were used as received. Platinum divinyltetramethyldisiloxane complex (Karstedt catalyst, ˜9%) was purchased from Johnson Matthey and was used as received. Catalyst 510, Karstedt catalyst in Polymer VS, with a platinum content of 5000 ppm and a platinum content of 0.5 wt %, was purchased from Evonik Hanse GmbH and was used as received. QPI-3100 (UV photo-catalyst supplied as 1000 ppm concentrate in vinyl silicone) was purchased from Polymer-G (Israel). Polymer VS500 (vinyl-terminated polydimethylsiloxane with a vinyl content of 0.14 mmol/g; VS500 for short), Polymer RV 5000, (vinyl-functional polydimethylsiloxane containing terminal and pendant vinyl groups, with a vinyl content of 0.4 mmol/g, XPRV5000 for short), Inhibitor 600 (an alkanol in Polymer VS, Inh600 for short), and polydimethylsiloxane compromising-SiH groups (Crosslinker 210, CL210 for short) were all obtained from Evonik Hanse GmbH. Chemical structures of primer and release components are depicted in FIGS. 2 and 3.

ITM Substrate Layer (“blanket body”) from bottom to top

Fabric layer (thickness 250 μm)

Compressible layer (NBR, thickness 600 μm)

Conductive layer (Acrylic rubber, thickness 160 μm)

Compliant layer (Acrylic rubber, thickness 160 μm)

Primer formulation—A two-component priming system was prepared according to the following formulation): Primer A-Primer G (82 parts) was added to TYZOR AA-75 (18 parts) and mixed thoroughly; Primer B-Primer G (59 parts) was added to vinyltrimethoxysilane (V3M) (35 parts) and to this was added 9% Karstedt catalyst (6 parts).

Thermal curable release formulation—The thermal curable release formulation was prepared according to the following formulation: Carbon black (0.8 wt % on total silicone) was suspended in a mixture of VS500/RV5000 (4/1). The mixture was allowed to stand for at least 2 hours for wetting followed by homogenization under high-shear mixing (6,000 rpm) for 3 minutes. This concentrate (depicted as master batch) was kept sealed until used. In an example curable release formulation, 10 parts of Crosslinker 210 and 5 parts of Inh600 were added to 100 parts of the master batch. The mixture was homogenized for 1 minute and left to stand until used. Shortly and just prior to coating, 0.5 part of catalyst 510 was added to the mixture above followed by homogenization at 3,000 rpm for 3 minutes. This mixture is stable for a few hours when kept sealed; however, best results are observed just after catalyst addition.

UV curable release formulation—The UV curable release formulation was prepared according to the following formulation: QPI-3100 (1000 ppm) was diluted in a mixture of VS500/RV5000 (4/1) to give a final catalyst concentration of 50 ppm. To this concentrate was added carbon black (0.8 wt %), allowed to stand for at least 2 hours for wetting and homogenized using a high-shear mixer at 6,000 rpm for 3 minutes. This concentrate (depicted as master batch) with the catalyst and carbon black was kept in the dark until used. In an example curable release formulation 10 parts of the Crosslinker 210, 0.5 part of Inh600 were added to 100 parts of the master batch and homogenized at 3,000 rpm for 3 minutes. When protected from light this mixture the formulation was stable at least for a month without any noticeable increase in the viscosity.

Method of Forming the Embossed ITM by Thermal Curing:

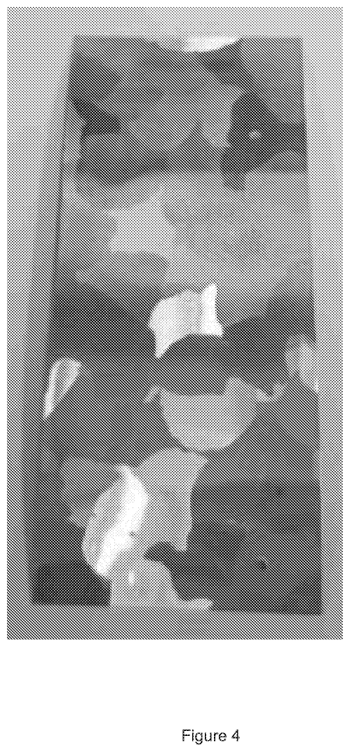

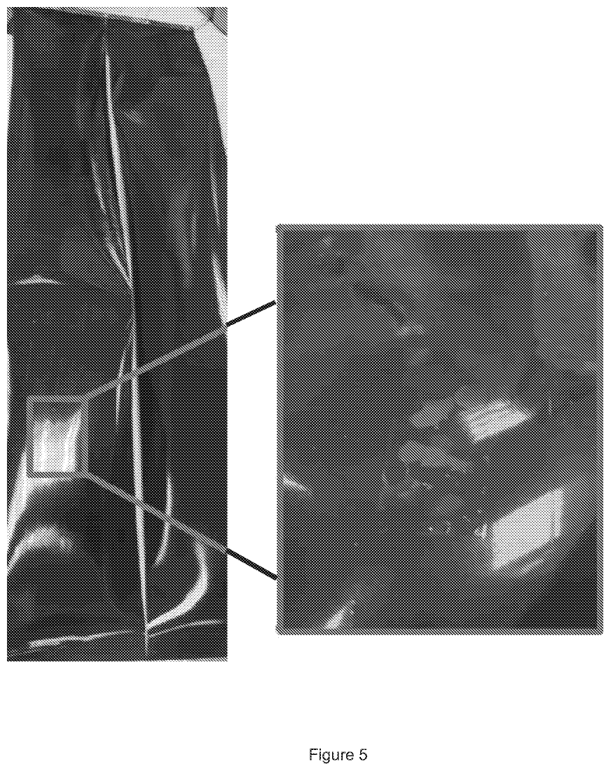

An ITM substrate layer (web presses of series III) was first laminated with CSL160/25 (Coveris®). All subsequent coatings were conducted using a continuous set of gravures coating stations at a constant coating speed of 5 (m/m). In an example coating experiment using two-component priming system, the primer A was applied utilizing 2.0 cm²/m³ gravure followed by hot-air knife with temperature fixed at 90° C. Next, primer B was applied using a 10.5 cm²/m³ gravure, followed by the thermal curable release formulation (gravure volume of 13.8 cm²/m³). The hologram master material (polyethylene or biaxially orientated polypropylene (BOPP), SpectraTek, see FIG. 4)—was placed over (and in contact with) the thermal curable release formulation without applying any pressure (other than the pressure exerted by the weight of the master material). For final curing all ITMs were placed in an oven at 120° C. for 4 hours. The hologram master material was then removed after cooling for at least 1 hour at ambient conditions. The holographic patterns and nanostructure had transferred reliably to the ITM and were highly visible (see FIG. 5).

Method of Forming the Embossed ITM by UV-A Curing:

For a UV-A curable release formulation, a similar procedure was applied except the UV-A curable release formulation was used instead of the thermal curable release formulation. The layer was cured using UV-A irradiation (UV-LED, 16 W/cm², wavelength 395 nm) and finally passed under dryers 90° C. The ITM was cured in an oven with a temperature set to 120° C. for a period of 1.5-2 hours. The hologram master material was then removed after cooling for at least 1 hour at ambient conditions

Adhesion Testing of the Embossed ITM

Isopar-L was added on top of a given region of the embossed ITM and allowed to stand for at least one minute. The isopar was wiped using a nonwoven polyester/cellulose (Essential wipes, Essentra). Adhesion was measured by aggressive rubbing (15 times on the both directions) on the region with a dry nonwoven wiping paper that has been folded three times. The extent of adhesion was visually evaluated by rating the visible damage from 1 to 4, where 1 represents a complete failure and total peel-off, 2 represents considerable damage, 3 represents minor visible damage, and 4 represents no damage. In this test, ITMs/blankets with less than a perfect score (i.e. grade 4) were not approved. Both embossed ITMs formed using the thermal curable release formulation by thermal curing and the UV-A curable release formulation by UV-A curing demonstrated a score of 4, therefore showing suitability for electrostatic printing methods. The abrasion test was conducted far from the holographic site.

Electrostatic Printing with an Embossed ITM

In the following Examples, HP Black Electroink™ for HP is a electrostatic ink composition containing a black pigment as a colorant, mixed resins Dupont Nucrel® 699 (copolymer of ethylene and 11 wt % methacrylic acid) and Honeywell A-C® 5120 (co-polymer of ethylene and 15 wt % acrylic acid) in ratio 4:1 respectively, Isopar™ L Fluid (Exxon Mobil, CAS Number 64742-48-9) and a NCD charge director In these examples, NCD indicates a natural charge director made of three components: KT (natural soya lecithin in phospholipids and fatty acids), BPP (basic barium petronate, i.e., a barium sulfonate salt of a 21-26 alkyl hydrocarbon alkyl, supplied by Chemtura) and GT (dodecyl benzene sulfonic acid isopropyl amine, supplied by Croda). The NCD composition comprises 6.6 wt. % KT, 9.8 wt. % BPP and 3.6 wt. % GT, balance of 80% Isopar.

Printing took place in a HP Indigo WS6600 Digital Press installed with the embossed ITM. The black HP electroink 4.5 was contacted with a latent image on the photoconductive imaging plate to form a developed toner image. The developed toner image was transferred to the embossed ITM, which was heated. The thermoplastic resin melted on the structured surface of the ITM to form a structured holographic toner image. This transfer can be repeated any number of times to form more than one ink layer (also referred to as a developed toner image) on the embossed ITM. It was found that more than one ink layer (thickness->1 μm), in other words, a higher coverage (e.g. 400% vs. 100%) increased the definition of the structured toner image due to a darker background.

The structured image was well-defined and undistorted despite the application of heat, and the presence of carrier fluid in the electrostatic ink which was expected to swell and distort the structured surface of the embossed ITM.

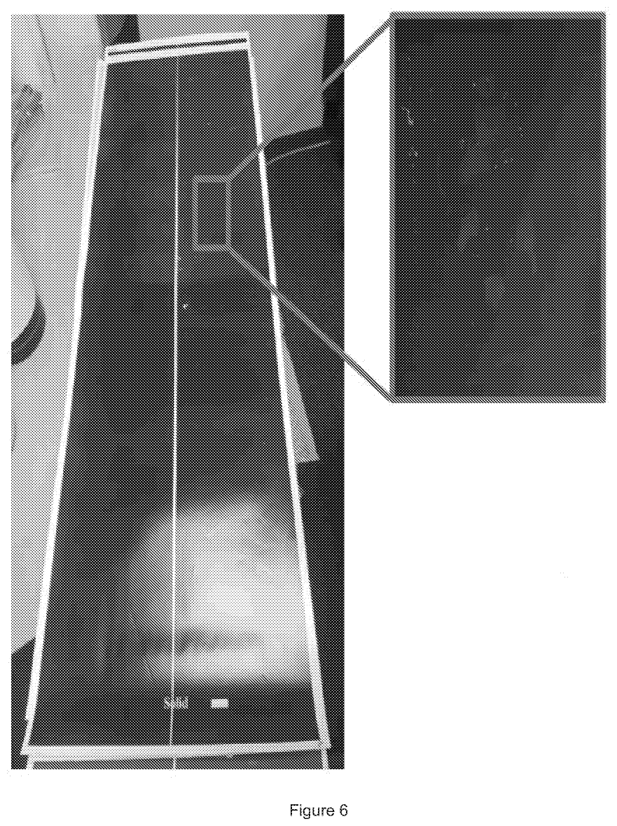

The structured holographic image was then successfully transferred onto the print substrate (primer coated paper—Condat with primer 050), with a defined nanostructure, as shown in FIG. 6.

1. An electrostatic printing method for forming a structured image on a print substrate, the method comprising:
providing an electrostatic ink composition;
contacting the electrostatic ink composition with a latent electrostatic image on a photoconductive surface to create a developed toner image;
transferring the developed toner image to an embossed intermediate transfer member to create a structured toner image; and
transferring the structured toner image to a print substrate.

2. An electrostatic printing method according to claim 1, wherein the embossed intermediate transfer member comprises a substrate layer, at least part of which is compressible and comprises an electrically conductive species; and; an outer release layer disposed on the substrate layer, the outer release layer comprising a structured surface.

3. An electrostatic printing method according to claim 1, wherein the structured image is a hologram or a watermark.

4. An electrostatic printing method according to claim 1, wherein the electrostatic ink composition comprises
a carrier fluid,
a thermoplastic resin,
a colorant and
a charge director or charge adjuvant.

5. An electrostatic printing method according to claim 1, wherein the embossed intermediate transfer member is heated to a temperature of about 80° C. to about 160° C.

6. A method of forming an embossed intermediate transfer member for use in electrostatic printing, the method comprising:
providing i) a substrate layer, at least part of which is compressible and comprises an electrically conductive species and ii) a layer of curable release formulation disposed on the substrate layer;
contacting a the curable release formulation with the surface of a master material, the surface having 3-dimensional structures thereon;
curing the release formulation to form an outer release layer comprising a structured surface disposed on the substrate layer; and
removing the master material.

7. A method of forming an embossed intermediate transfer member according to claim 6, wherein the master material comprises polyethylene or biaxially orientated polypropylene.

8. A method of forming an embossed intermediate transfer member according to claim 6, wherein the 3-dimensional structures are nanostructures or microstructures.

9. A method of forming an embossed intermediate transfer member for use in electrostatic printing according to claim 6, wherein the curable release formulation is cured thermally or cured by irradiation with UV light.

10. A method of forming an embossed intermediate transfer member for use in electrostatic printing according to claim 6, wherein the curable release formulation comprises:
a polyalkylsiloxane comprising at least two vinyl groups,
a polyalkylsiloxane crosslinker and
at least one of a UV photoinitiator or a transition metal hydrosilylation catalyst.

11. An embossed intermediate transfer member for use in electrostatic printing, the embossed intermediate transfer member comprising:
a substrate layer, at least part of which is compressible and comprises an electrically conductive species; and;
an outer release layer disposed on the substrate layer, the outer release layer comprising a structured surface.

12. An embossed intermediate transfer member according to claim 11, wherein the structured surface is
a nanostructured surface for forming a hologram, or
a microstructured surface for forming a watermark.

13. An embossed intermediate transfer for use in electrostatic printing according to claim 11, wherein the compressible part comprises a material selected from an acrylic rubber (ACM), nitrile rubber (NBR), a hydrogenated nitrile rubber (HNBR), a polyurethane elastomer (PU) and an ethylene propyelene diene terpolymer (EPDM) rubber.

14. An embossed intermediate transfer member for use in electrostatic printing according to claim 11, wherein the outer release layer is a cured silicone release layer.

15. An embossed intermediate transfer member for use in electrostatic printing according to claim 11, wherein the outer release layer is formed from a curable release composition comprising
a polyalkylsiloxane comprising at least two vinyl groups,
a polyalkylsiloxane crosslinker and
at least one of a UV photoinitiator or a transition metal hydrosilylation catalyst
